(19) United States
(12) Patent Application Publication
(10) Pub. No.: US 2026/0292540 A1
(43) Pub. Date: Sep. 24, 2026

(54) DYNAMIC ISOCHRONOUS PARAMETER UPDATES FOR BLUETOOTH LOW ENERGY COMMUNICATION LINKS

(71) Applicant: QUALCOMM Incorporated, San Diego, CA (US)

(72) Inventors: Jie ZENG, Shanghai (CN); Runyuan LIU, Shanghai (CN); Xie YINGCHAO, Shanghai (CN); Liang HE, Shanghai (CN); Fan WU, Shanghai (CN); Joel LINSKY, San Diego, CA (US); Mayank BATRA, Cambridge (GB)

(21) Appl. No.: 19/469,975

(22) PCT Filed: May 29, 2023
(86) PCT No.: PCT/CN2023/096744

§ 371 Date: Sep. 26, 2025

(51) Int. Cl. H04W 24/02; H04L 12/40; H04W 76/10

(52) U.S. Cl. CPC H04W 24/02; H04L 12/40058; H04W 76/10

(57) ABSTRACT

This disclosure provides methods, components, devices and systems for dynamic isochronous (ISO) parameter updates for Bluetooth Low Energy (BLE) communication links. Some aspects more specifically relate to dynamic or “on-the-fly” parameter updates for an ISO communication link without shutting down and re-establishing the ISO communication link. In some implementations, a central device may create one or more parameter sets for an ISO communication link and the central device may notify one or more remote devices of each of the one or more parameter sets. For a given notified parameter set, a remote device may accept or reject the parameter set and, accordingly, transmit either an accept indication or a reject indication for the parameter set based on being notified of the parameter set. The central device may transmit an indication of a dynamic update to a parameter set of the accepted parameter sets while the ISO communication link is active.

### CROSS REFERENCE

This application is a 371 National Stage of PCT Application No. PCT/CN2023/096744, filed on May 29, 2023, entitled “DYNAMIC ISOCHRONOUS PARAMETER UPDATES FOR BLUETOOTH LOW ENERGY COMMUNICATION LINKS”, and assigned to the assignee hereof. The disclosure of the prior Application is considered part of and is incorporated by reference into this Patent Application.

### TECHNICAL FIELD

This disclosure relates to wireless communication and, more specifically, to dynamic isochronous parameter updates for Bluetooth Low Energy (BLE) communication links.

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (such as time, frequency, and power). A wireless network, for example a wireless local area network (WLAN), such as a Wi-Fi (institute of Electrical and Electronics Engineers (IEEE) 802.11) network may include an access point (AP) that may communicate with one or more wireless or mobile devices. The AP may be coupled with a network, such as the Internet, and may enable a mobile device to communicate via the network (or communicate with other devices coupled with the AP). A wireless device may communicate with a network device bi-directionally. For example, in a WLAN, a device may communicate with an associated AP via downlink (such as the communication link from the AP to the device) and uplink (such as the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication performable at a first wireless communication device. The method may include transmitting information associated with one or more parameter sets of an isochronous (ISO) communication link between the first wireless communication device and at least a second wireless communication device, receiving an accept indication associated with at least a first parameter set of the one or more parameter sets, transmitting an indication of an update from an initial parameter set of the ISO communication link to the first parameter set, where the indication includes an identifier (ID) of the first parameter set and a time at which the first parameter set is to be applied, and communicating, prior to the time at which the first parameter set is to be applied, using the initial parameter set and, after the time at which the first parameter set is to be applied, using the first parameter set.

Another innovative aspect of the subject matter described in this disclosure can be implemented in a first wireless communication device. The first wireless communication device may include at least one memory and at least one processor communicatively coupled with the at least one memory. The at least one processor may be operable to cause the first wireless communication device to transmit information associated with one or more parameter sets of an ISO communication link between the first wireless communication device and at least a second wireless communication device, receive an accept indication associated with at least a first parameter set of the one or more parameter sets, transmit an indication of an update from an initial parameter set of the ISO communication link to the first parameter set, where the indication includes an ID of the first parameter set and a time at which the first parameter set is to be applied, and communicating, prior to the time at which the first parameter set be to be applied, using the initial parameter set and, after the time at which the first parameter set is to be applied, using the first parameter set.

Another innovative aspect of the subject matter described in this disclosure can be implemented in a first wireless communication device. The first wireless communication device may include means for transmitting information associated with one or more parameter sets of an ISO communication link between the first wireless communication device and at least a second wireless communication device, means for receiving an accept indication associated with at least a first parameter set of the one or more parameter sets, means for transmitting an indication of an update from an initial parameter set of the ISO communication link to the first parameter set, where the indication includes an ID of the first parameter set and a time at which the first parameter set is to be applied, and means for communicating, prior to the time at which the first parameter set is to be applied, using the initial parameter set and, after the time at which the first parameter set is to be applied, using the first parameter set.

Another innovative aspect of the subject matter described in this disclosure can be implemented in a non-transitory computer-readable medium storing code for wireless communication performable at a first wireless communication device. The code may include instructions executable by a processor to transmit information associated with one or more parameter sets of an ISO communication link between the first wireless communication device and at least a second wireless communication device, receive an accept indication associated with at least a first parameter set of the one or more parameter sets, transmit an indication of an update from an initial parameter set of the ISO communication link to the first parameter set, where the indication includes an ID of the first parameter set and a time at which the first parameter set is to be applied, and communicating, prior to the time at which the first parameter set be to be applied, using the initial parameter set and, after the time at which the first parameter set is to be applied, using the first parameter set.

Some implementations of the method, first wireless communication devices, and non-transitory computer-readable medium described herein may further include operations, features, means, or instructions for transmitting, from a central host of the first wireless communication device to a central controller of the first wireless communication device, requests to create a set of multiple parameter sets, the set of multiple parameter sets including the one or more parameter sets and receiving, at the central host from the central controller, accept indications associated with the one or more parameter sets.

Some implementations of the method, first wireless communication devices, and non-transitory computer-readable medium described herein may further include operations, features, means, or instructions for receiving, at the central host from the central controller, one or more reject indications associated with one or more second parameter sets, where the set of multiple parameter sets includes the one or more parameter sets and the one or more second parameter sets, and where the one or more parameter sets excludes the one or more second parameter sets in accordance with the one or more reject indications associated with the one or more second parameter sets.

Some implementations of the method, first wireless communication devices, and non-transitory computer-readable medium described herein may further include operations, features, means, or instructions for receiving a reject indication associated with a second parameter set of the one or more parameter sets and refraining from transmitting a second indication of a second update to the second parameter set in accordance with the reject indication associated with the second parameter set.

Another innovative aspect of the subject matter described in this disclosure can be implemented in a method for wireless communication performable at a second wireless communication device. The method may include receiving information associated with one or more parameter sets of an ISO communication link between a first wireless communication device and at least the second wireless communication device, transmitting an accept indication associated with at least a first parameter set of the one or more parameter sets, receiving an indication of an update from an initial parameter set of the ISO communication link to the first parameter set, where the indication includes an ID of the first parameter set and a time at which the first parameter set is to be applied, and communicating, prior to the time at which the first parameter set is to be applied, using the initial parameter set of the ISO communication link and, after the time at which the first parameter set is to be applied, using the first parameter set.

Another innovative aspect of the subject matter described in this disclosure can be implemented in a second wireless communication device. The second wireless communication device may include at least one memory and at least one processor communicatively coupled with the at least one memory. The at least one processor may be operable to cause the second wireless communication device to receive information associated with one or more parameter sets of an ISO communication link between a first wireless communication device and at least the second wireless communication device, transmit an accept indication associated with at least a first parameter set of the one or more parameter sets, receive an indication of an update from an initial parameter set of the ISO communication link to the first parameter set, where the indication includes an ID of the first parameter set and a time at which the first parameter set is to be applied, and communicating, prior to the time at which the first parameter set be to be applied, using the initial parameter set of the ISO communication link and, after the time at which the first parameter set is to be applied, using the first parameter set.

Another innovative aspect of the subject matter described in this disclosure can be implemented in a second wireless communication device. The second wireless communication device may include means for receiving information associated with one or more parameter sets of an ISO communication link between a first wireless communication device and at least the second wireless communication device, means for transmitting an accept indication associated with at least a first parameter set of the one or more parameter sets, means for receiving an indication of an update from an initial parameter set of the ISO communication link to the first parameter set, where the indication includes an ID of the first parameter set and a time at which the first parameter set is to be applied, and means for communicating, prior to the time at which the first parameter set is to be applied, using the initial parameter set of the ISO communication link and, after the time at which the first parameter set is to be applied, using the first parameter set.

Another innovative aspect of the subject matter described in this disclosure can be implemented in a non-transitory computer-readable medium storing code for wireless communication performable at a second wireless communication device. The code may include instructions executable by a processor to receive information associated with one or more parameter sets of an ISO communication link between a first wireless communication device and at least the second wireless communication device, transmit an accept indication associated with at least a first parameter set of the one or more parameter sets, receive an indication of an update from an initial parameter set of the ISO communication link to the first parameter set, where the indication includes an ID of the first parameter set and a time at which the first parameter set is to be applied, and communicating, prior to the time at which the first parameter set be to be applied, using the initial parameter set of the ISO communication link and, after the time at which the first parameter set is to be applied, using the first parameter set.

Some implementations of the method, second wireless communication devices, and non-transitory computer-readable medium described herein may further include operations, features, means, or instructions for receiving the information associated with the one or more parameter sets at the second wireless communication device from the first wireless communication device, transmitting the accept indication associated with the first parameter set from the second wireless communication device to the first wireless communication device, and storing, in a memory of the second wireless communication device, the first parameter set in accordance with the accept indication associated with the first parameter set.

Some implementations of the method, second wireless communication devices, and non-transitory computer-readable medium described herein may further include operations, features, means, or instructions for transmitting, from the second wireless communication device to the first wireless communication device, a reject indication associated with a second parameter set of the one or more parameter sets and discarding, from a memory of the second wireless communication device, the second parameter set in accordance with the reject indication associated with the second parameter set.

Some implementations of the method, second wireless communication devices, and non-transitory computer-readable medium described herein may further include operations, features, means, or instructions for receiving, via the indication of the update to the first parameter set, an indication of a flush rule associated with the update to the first parameter set.

In some implementations of the method, second wireless communication devices, and non-transitory computer-readable medium described herein, the flush rule may be exclusively applied to one or more transition protocol data units that may be generated prior to the time at which the first parameter set may be to be applied and, in accordance with an initial flush rule associated with the initial parameter set, may have one or more respective original flush points after the time at which the first parameter set may be to be applied.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of a wireless communication system that supports dynamic isochronous (ISO) parameter updates for Bluetooth Low Energy (BLE) communication links according to some aspects of the present disclosure.

FIG. 2 shows an example of a signaling diagram that supports dynamic ISO parameter updates for BLE communication links according to some aspects of the present disclosure.

FIGS. 3 and 4 show examples of communication timelines that support dynamic ISO parameter updates for BLE communication links according to some aspects of the present disclosure.

FIG. 5 shows an example of an ISO parameter update that supports dynamic ISO parameter updates for BLE communication links according to some aspects of the present disclosure.

FIGS. 6 and 7 show examples of process flows that support dynamic ISO parameter updates for BLE communication links according to some aspects of the present disclosure.

FIG. 8 shows an example of a parameter set tracking diagram that supports dynamic ISO parameter updates for BLE communication links according to some aspects of the present disclosure.

FIG. 9 shows an example of a process flow that supports dynamic ISO parameter updates for BLE communication links according to some aspects of the present disclosure.

FIG. 10 shows a block diagram of an example wireless communication device that supports dynamic ISO parameter updates for BLE communication links according to some aspects of the present disclosure.

FIGS. 11 and 12 show flowcharts illustrating example processes that support dynamic ISO parameter updates for BLE communication links according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to audio communication links, including Bluetooth Low Energy (BLE) isochronous (ISO) audio communication links. Some aspects more specifically relate to dynamic or “on-the-fly” parameter updates for an ISO communication link without shutting down and re-establishing the ISO communication link. In some implementations, for example, a central device may create one or more parameter sets for an ISO communication link (which may be equivalently referred to or understood as one or more alternative configurations of the ISO communication link). Each respective parameter set may include a respective set of ISO parameters for the ISO communication link, such as a number of sub-events (NSE) parameter, a burst number (BN) parameter, a flush timeout (FT) parameter, an ISO interval parameter, and the like. Further, each respective parameter set may be associated with a unique parameter set identifier (ID), which may be equivalently referred to or understood as a configuration ID, and a mode ID, which may be shared across two or more parameter sets.

In accordance with creating the one or more parameters sets for the ISO communication link, the central device may notify one or more remote devices (which may be equivalently referred to or understood as one or more peripheral devices, and which may include a wireless headset, wireless earbuds, a remote speaker, or the like) of each of the one or more parameter sets. For a given notified parameter set, a remote device may accept or reject the parameter set and, accordingly, transmit either an accept indication or a reject indication for the parameter set based on being notified of the parameter set. In other words, a remote device may receive, from the central device, a notification of a parameter set and may transmit, to the central device, either an accept indication or a reject indication for the parameter set. The central device may store information relating to which parameter sets are accepted by all remote devices associated with the ISO communication link and, in the course of communication via the ISO communication link (such as while an associated ISO channel is active), may transmit an indication of an update to a parameter set of the accepted parameter sets (and may refrain from indicating an update to any parameter set for which the central device receives at least one reject indication). For example, if the central device detects a change in a radio frequency (RF) environment (such as new or higher interference or a change in a coexistence scenario), the central device may transmit an indication of an update from a current parameter set to a new parameter set. In some implementations, the central device may convey, via the indication of the update, a time at which the update is to be performed and a flush rule associated with any transition packets (which may be understood as packets initially transmitted in accordance with the current parameter set and that have a flushing point after the time at which the update is to be performed).

Particular aspects of the subject matter described in this disclosure can be implemented to realize one or more of the following potential advantages. In some implementations, by creating one or more alternative parameter sets for an ISO communication link and negotiating with one or more remote devices as to which of the alternative parameter sets are supported in advance, the described techniques can be used to facilitate dynamic or “on-the-fly” parameter updates for an ISO communication link without shutting down (such as tearing down) and re-establishing the ISO communication link, which may avoid delays and reduce audio glitches associated with link shutdown and re-establishment. By leveraging dynamic or “on-the-fly” ISO parameter updates to adapt to a change in a coexistence scenario (such as in accordance with a coexistence with Wi-Fi communication), the central device and the remote device(s) may achieve greater coexistence performance as communication associated with different wireless communication protocols (such as different wireless communication technologies) may experience less interference with each other and/or may be coordinated with each other (such as in accordance with a relative prioritization).

Further, by enabling each remote device to provide an accept indication or a reject indication for each notified parameter set, the described techniques can be used to achieve greater coordination and more seamless updates because the central device can selectively request parameter set updates that are supported by each remote device (and avoid requesting parameter set updates that are not supported by a remote device). Further, by indicating a flush rule associated with any transition packets along with an indication of an update to a new parameter set, the described techniques can be used to maintain synchronization between the central device and one or more remote devices regarding packet count and flush points because the central device and the one or more remote devices may use the same indicated flush rule. As a result of such an avoidance of delays and reduced audio glitches associated with link shutdown and re-establishment, greater coordination and more seamless updates, and maintained synchronization when parameter set updates occur, the described techniques can be further used to achieve more reliable communication, longer battery life (by, for example, avoiding some link shutdown and re-establishment operations) lower latency, higher data rates, greater spectral efficiency, and greater system capacity, among other benefits.

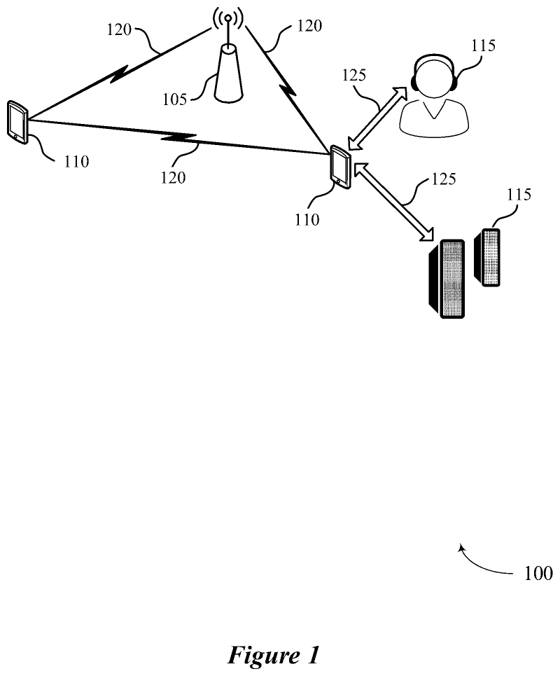

FIG. 1 shows an example of a wireless communication system 100 that supports dynamic ISO parameter updates for BLE communication links according to some aspects of the present disclosure. In some implementations, the wireless communication system 100 may include or refer to a wireless personal area network (PAN), a wireless local area network (WLAN, a Wi-Fi network) configured in accordance with various aspects of the present disclosure. The wireless communication system 100 may include an access point (AP) 105, devices 110 (such as which may be referred to as source devices or central devices), and paired devices 115 (such as which may be referred to as sink devices, remote devices, and peripheral devices) implementing WLAN communications (such as Wi-Fi communications) and/or Bluetooth communications. For example, devices 110 may include cell phones, user equipment (UEs), wireless stations (STAs), mobile stations, personal digital assistant (PDAs), other handheld devices, netbooks, notebook computers, tablet computers, laptops, or some other suitable terminology. Paired devices 115 may include Bluetooth-enabled devices capable of pairing with other Bluetooth-enabled devices (such as such as devices 110), which may include wireless audio devices (such as headsets, earbuds, speakers, earpieces, headphones), display devices (such as TVs, computer monitors), microphones, meters, or valves.

Bluetooth communications may refer to a short-range communication protocol and may be used to connect and exchange information between devices 110 and paired devices 115 (such as between mobile phones, computers, digital cameras, wireless headsets, speakers, keyboards, mice or other input peripherals, and similar devices). Bluetooth systems (such as aspects of wireless communication system 100) may be organized using a central-peripheral relationship employing a time-division duplex protocol having, for example, defined time slots of 625 microseconds, in which transmission alternates between the central device (such as a device 110) and one or more peripheral devices (such as paired devices 115). In some implementations, a device 110 may generally refer to a central device, and a paired device 115 may refer to a peripheral device in the wireless communication system 100. As such, in some examples, a device may be referred to as either a device 110 or a paired device 115 based on the Bluetooth role configuration of the device. That is, designation of a device as either a device 110 or a paired device 115 may not necessarily indicate a distinction in device capability, but rather may refer to or indicate roles held by the device in the wireless communication system 100. Generally, device 110 may refer to a wireless communication device capable of wirelessly exchanging data signals with another device (such as a paired device 115), and paired device 115 may refer to a device operating in a peripheral role, or to a short-range wireless communication device capable of exchanging data signals with the device 110 (such as using Bluetooth communication protocols).

A Bluetooth-enabled device may be compatible with some Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a specified way, and may include information such as suggested user interface formats or particular options and parameters at each layer of the Bluetooth protocol stack. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs (such as roles for a device 110 and a paired device 115) that together form a single use case called a profile (such as for communications between the device 110 and the paired device 115). One example profile defined in the Bluetooth specification is the Handsfree Profile (HFP) for voice telephony, in which one device (such as a device 110) implements an Audio Gateway (AG) role and the other device (such as a paired device 115) implements a Handsfree (HF) device role. Another example is the Advanced Audio Distribution Profile (A2DP) for high-quality audio streaming, in which one device (such as device 110) implements an audio source device (SRC) role and another device (such as paired device 115) implements an audio sink device (SNK) role.

For a commercial Bluetooth-enabled device that implements one role in a profile to function properly, another device that implements the corresponding role may be present within the radio range of the first device. For example, in order for an HF device such as a Bluetooth headset to function according to the Handsfree Profile, a device implementing the AG role (such as a cell phone) may have to be present within radio range. Likewise, in order to stream high-quality mono or stereo audio according to the A2DP, a device implementing the SNK role (such as Bluetooth headphones or Bluetooth speakers) may have to be within radio range of a device implementing the SRC role (such as a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having various characteristics (such as flow control, acknowledgment mechanisms, repeat mechanisms, sequence numbering, or scheduling behavior). The Bluetooth protocol stack may be split in two parts: a controller stack including the timing critical radio interface, and a host stack handling high level data. The controller stack may be generally implemented in a low cost silicon device including a Bluetooth radio and a microprocessor. The controller stack may be responsible for setting up connection links 125 such as asynchronous connection-oriented links, (or asynchronous connection-oriented connections), synchronous connection-orientated (SCO) links (or SCO connections), extended synchronous connection-oriented (eSCO) links (or eSCO connections), or other logical transport channel links.

In some implementations, the controller stack may implement link management protocol (LMP) functions or low energy (LE) link layer (LL) functions. The host stack may be generally implemented as part of an operating system, or as an installable package on top of an operating system. The host stack may be responsible for logical link control and adaptation protocol (L2CAP) functions, Bluetooth network encapsulation protocol (BNEP) functions, or service discovery protocol (SDP) functions. In some implementations, the controller stack and the host stack may communicate via a host controller interface (HCI). In some other implementations, (such as for integrated devices such as Bluetooth headsets), the host stack and controller stack may be run on the same microprocessor to reduce mass production costs. For such host-less systems, the HCI may be optional, and may be implemented as an internal software interface.

A connection link 125 may be established between two Bluetooth-enabled devices (such as between a device 110 and a paired device 115) and may provide for communications or services (such as according to some Bluetooth profile). For example, a Bluetooth connection may be an eSCO connection for voice call (such as which may allow for retransmission) or an ACL connection for music streaming (such as A2DP). For example, eSCO packets may be transmitted in predetermined time slots (such as 6 Bluetooth slots each for eSCO). The regular interval between the eSCO packets may be specified when the Bluetooth link is established. The eSCO packets to/from a specific device (such as paired device 115) are acknowledged, and may be retransmitted if not acknowledged during a retransmission window. In addition, audio may be streamed between a device 110 and a paired device 115 using an ACL connection (A 2DP profile). In some examples, the ACL connection may occupy 1, 3, or 5 Bluetooth slots for data or voice. Other Bluetooth profiles supported by Bluetooth-enabled devices may include BLE (such as providing considerably reduced power consumption and cost while maintaining a similar communication range) or human interface device profile (HID) (such as providing low latency links with low power requirements).

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some implementations, Bluetooth and WLAN communications may share a same medium, such as the same unlicensed frequency medium. In such examples, a device 110 may support WLAN communications via AP 105 (such as over communication links 120). The AP 105 and the associated devices 110 may represent a basic service set (BSS) or an extended service set (ESS). The various devices 110 in the network may be able to communicate with one another through the AP 105. In some examples, the AP 105 may be associated with a coverage area, which may represent a basic service area (BSA).

Devices 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, and 802.11be. In some implementations, peer-to-peer connections or ad hoc networks may be implemented within the wireless communication system 100, and devices may communicate with each other via communication links 120 (such as Wi-Fi Direct connections, Wi-Fi Tunneled Direct Link Setup (TDLS) links, peer-to-peer communication links, other peer or group connections). AP 105 may be coupled with a network, such as the Internet, and may enable a device 110 to communicate via the network (or communicate with other devices 110 coupled with the AP 105). A device 110 may communicate with a network device bi-directionally. For example, in a WLAN, a device 110 may communicate with an associated AP 105 via downlink (such as the communication link from the AP 105 to the device 110) and uplink (such as the communication link from the device 110 to the AP 105).

In some implementations, content, media, audio, etc. exchanged between a device 110 and a paired device 115 may originate from a WLAN. For example, in some examples, device 110 may receive audio from an AP 105 (such as via WLAN communications), and the device 110 may then relay or pass the audio to the paired device 115 (such as via Bluetooth communications). In some implementations, some types of Bluetooth communications (such as such as high quality or high definition (HD) Bluetooth) may be associated with enhanced quality of service. For example, in some examples, delay-sensitive Bluetooth traffic may have higher priority than WLAN traffic.

In some aspects, the wireless communication system 100 may support one or more configuration-or signaling-based mechanisms associated with facilitating dynamic or “on-the-fly” parameter updates for an ISO communication link (such as a connection link 125) without shutting down and re-establishing the ISO communication link. In some implementations, a device 110 (such as a central device) may create one or more parameter sets for an ISO communication link (which may be equivalently referred to or understood as one or more alternative configurations of the ISO communication link). In accordance with creating the one or more parameters sets for the ISO communication link, the device 110 may notify one or more paired devices 115 (which may be equivalently referred to or understood as one or more remote devices or one or more peripheral devices) of each of the one or more parameter sets. For a given notified parameter set, a paired device 115 may accept or reject the parameter set and, accordingly, transmit either an accept indication or a reject indication for the parameter set based on being notified of the parameter set. The device 110 may store information relating to which parameter sets are accepted by all paired devices 115 associated with the ISO communication link.

As such, in the course of communication via the ISO communication link (such as while an associated ISO channel is active), the device 110 may transmit an indication of an update to a parameter set of the accepted parameter sets (and may refrain from indicating an update to any parameter set for which the central device receives at least one reject indication). For example, if the device 110 detects a change in an RF environment (such as new or higher interference or a change in a coexistence scenario), the device 110 may transmit an indication of an update from a previous parameter set to a new parameter set. In some implementations, the device 110 may convey, via the indication of the update, a time at which the update is to be performed and a flush rule associated with any transition packets. As described herein, a transition packet may be understood as a packet initially transmitted in accordance with a previous parameter set that has a flushing point after the time at which an update is to be performed.

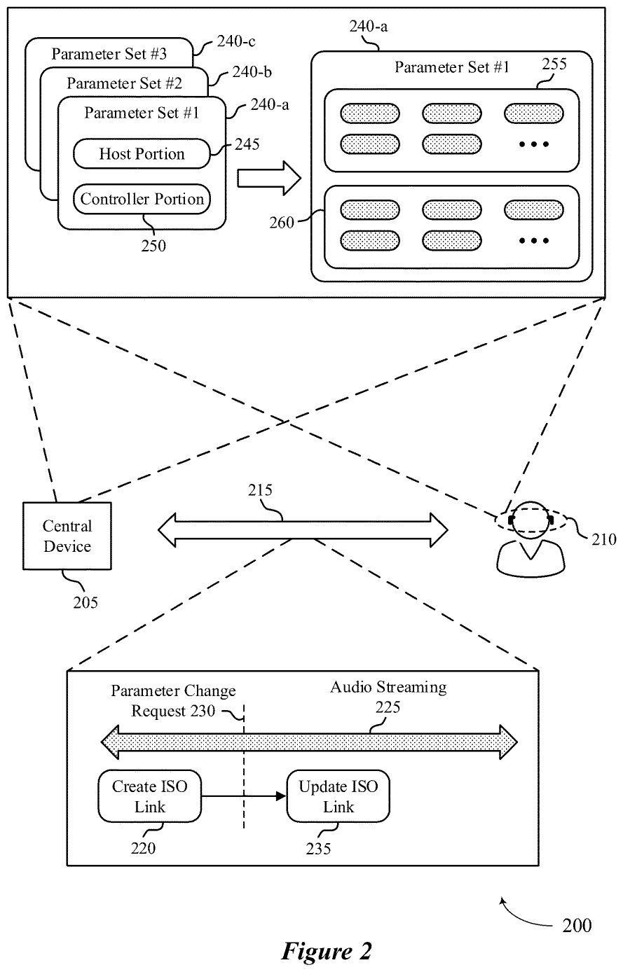

FIG. 2 shows an example of a signaling diagram 200 that supports dynamic ISO parameter updates for BLE communication links according to some aspects of the present disclosure. The signaling diagram 200 may implement or be implemented to realize aspects of the wireless communication system 100. For example, the signaling diagram 200 illustrates communication between a central device 205 and a remote device 210 (such as one or more remote devices 210) via a communication link 215 (which may be an example of an ISO communication link). In some implementations, the central device 205 and the remote device 210 may support one or more configuration-or signaling-based mechanisms according to which the central device 205 and the remote device 210 can dynamically update ISO parameters associated with the communication link 215 (without link teardown and re-establishment). In other words, the central device 205 and the remote device 210 may support and communicate in accordance with an ISO parameter update protocol.

In some systems, wireless communication devices may be unable to dynamically change audio link parameters (such as BLE ISO audio link parameters) once an ISO link is established, which may adversely impact communication via the communication link 215 in some scenarios. For example, a host device may detect (such as determine, identify, select, or otherwise ascertain) that a current set of audio link parameters is no longer suitable due to a change in a surrounding RF environment. Such a change in a surrounding RF environment may be associated with new or relatively higher interference (such as greater than a threshold amount of interference).

Additionally, or alternatively, a host device may detect (such as determine, identify, select, or otherwise ascertain) that a current set of audio link parameters is no longer suitable due to a change in a coexistence scenario. Such a change in a coexistence scenario may be associated with a change in one or more communication parameters used by another wireless communication technology (such as Wi-Fi, which may be equivalently referred to or understood as a WLAN communication technology). Such communication parameters may include, for example, an operating bandwidth (such as a primary subchannel), an RF band (such as 2.4 GHz, 5 GHz, or 6 GHz), or a communication interval (such as a target wake time (TWT) or a service period (SP) duration) associated with the other wireless communication technology. For example, WLAN communication may switch between different bandwidths or may switch between latency sensitive traffic and non-latency sensitive traffic based on a specific use case (such as based on whether the WLAN communication is associated with a high definition (HD) video, a low latency gaming application, a conference call, or the like) to achieve better performance such that, for some use cases, the WLAN communication may interfere with communication via the communication link 215. In other words, WLAN communication may occasionally interfere with Bluetooth communication due to the various (and changing) use cases WLAN communication may support.

As such, if either new or higher interference or a change in a coexistence scenario is detected and if audio link parameters are unable to be changed dynamically (such as “on-the-fly”), communication via the communication link 215 may experience collisions or otherwise unsuccessful transmission attempts, which may result in audio glitches and a relatively poor user experience. Further, to adjust the audio link parameters to reduce a likelihood for collisions or otherwise increase a likelihood of successful transmissions, a host device may be constrained to disconnect an ISO link and initiate a connection to create a new ISO link. Such a disconnection and re-connection via a new ISO link may cause a noticeable delay in an audio stream, which also may result in an audio glitch and a relatively poor user experience (especially if changes in interference levels or coexistence scenarios are frequent).

Accordingly, in some implementations of the present disclosure, the central device 205 and the remote device 210 may support one or more configuration-or signaling-based mechanisms according to which the central device 205 and the remote device 210 can dynamically update ISO parameters associated with the communication link 215 (without link teardown and re-establishment, such as without a shutdown of the ISO link). For example, the central device 205 and the remote device 210 may create an ISO link at 220 and initiate, activate, or otherwise participate in audio streaming 225 (such as music streaming) in accordance with creating the ISO link (such as the communication link 215). At some point after the creation of the ISO link (and during the audio streaming 225), the central device 205 may receive, obtain, detect, or otherwise determine a parameter change request 230 associated with a configuration of the ISO link.

In some aspects, the central device 205 may receive, obtain, detect, or otherwise determine the parameter change request 230 in accordance with a change in an interference level at the central device 205 (or at the remote device 210) or a change in a coexistence scenario at the central device 205. In accordance with the parameter change request 230, the central device 205 and the remote device 210 may update the ISO link (such as the communication link 215) at 235. In some implementations, the central device 205 and the remote device 210 may update the ISO link (such as switch from a first parameter set for the communication link 215 to a second parameter set for the communication link 215) in such a manner as to avoid interrupting the audio streaming 225. In other words, in accordance with the techniques described herein, the central device 205 and the remote device 210 may update the ISO link while maintaining the audio streaming 225 via an active channel associated with the ISO link.

To facilitate such an updating of the ISO link while maintaining the audio streaming 225 (such as without interrupting or disconnecting the audio streaming 225 and creating a new ISO link), the central device 205 may create (such as select, identify, determine, generate, or configure) one or more alternative parameter sets for the communication link 215 and may dynamically indicate updates to different parameter sets of the one or more alternative parameter sets if the central device 205 detects that an initial parameter set (such as a current or default parameter set) is no longer suitable for communication via the communication link 215. For example, the central device 205 may create a parameter set 240-a, a parameter set 240-b, and a parameter set 240-c and may notify (such as inform) the remote device 210 of each of the parameter set 240-a, the parameter set 240-b, and the parameter set 240-c.

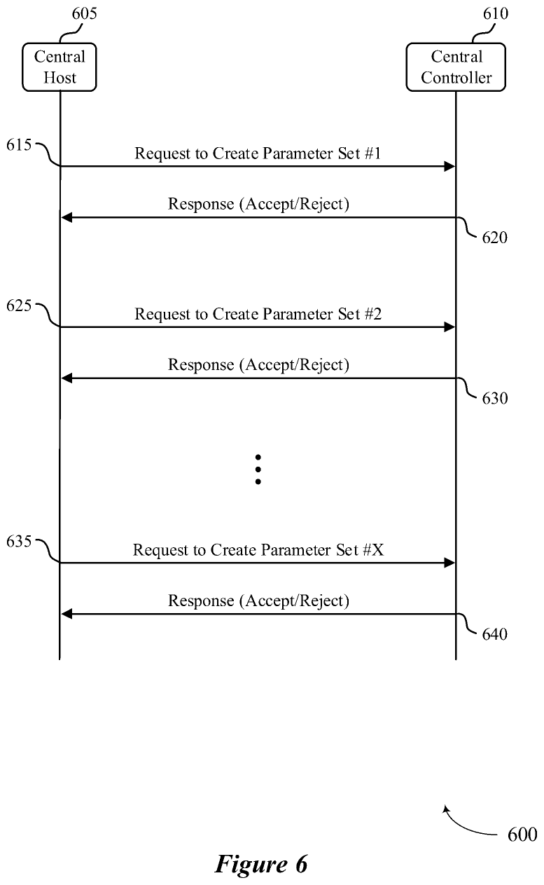

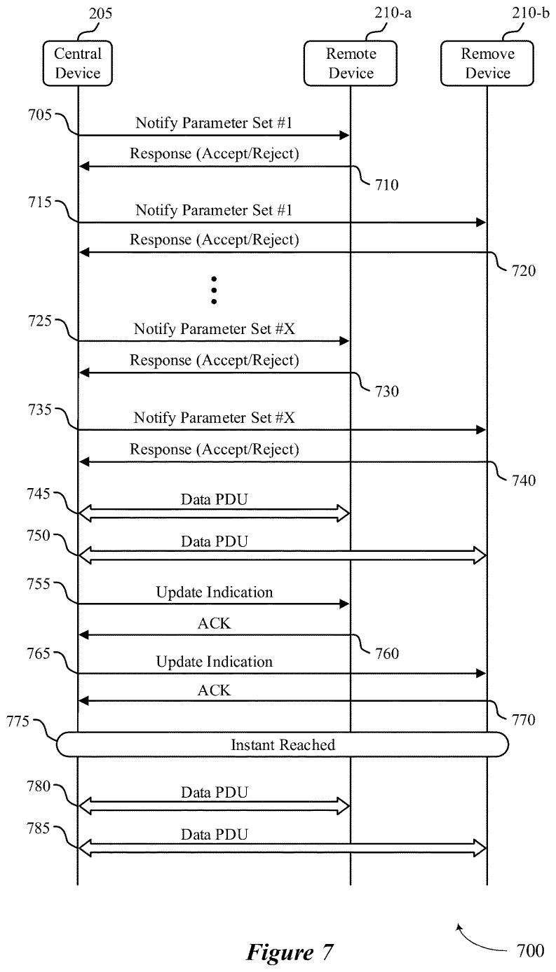

As such, both the central device 205 and the remote device 210 may store information associated with each of the one or more alternative parameter sets and retrieve relevant information associated with a parameter set dynamically or “on-the-fly” (such as whenever an update to that parameter set is indicated). For example, both the central device 205 and the remote device 210 may retrieve (and apply) information associated with the parameter set 240-a in accordance with the central device indicating an update to the parameter set 240-a. Additional details relating to such a creation of the multiple parameter sets at the central device 205 and the notification of the multiple parameter sets to the remote device 210 are illustrated by and described herein, including with reference to FIGS. 6 and 7.

A parameter set of the one or more alternative parameter sets may be equivalently referred to or understood as a configuration, such as a configuration of the communication link 215. Accordingly, “parameter set” and “configuration” may be used interchangeably. For example, a configuration may include or pertain to a corresponding parameter set, a parameter set may define or provide a corresponding configuration, information associated with a configuration may be associated with (such as indicate) a corresponding parameter set, and the like. In other words, a parameter set may refer to one or more parameters that a wireless communication device (such as one or both of the central device 205 and the remote device 210) may apply or follow to communicate via the communication link 215, and applying or communicating in accordance with a specific set of one or more parameters for communication via the communication link 215 may be understood as a specific configuration of the communication link 215.

Each parameter set (such as each configuration) may have a unique parameter set ID (which may be equivalently referred to or understood as a configuration ID, such as a config_ID) and a mode ID, which may be the same as a mode ID for another parameter set. A configuration ID and a mode ID of a default parameter set may both be 0, and alternative parameter sets may be associated with configuration IDs and mode IDs starting from a non-zero value, such as 1. In other words, a parameter set ID may be unique and specific to one parameter set while multiple parameter sets may have the same mode ID. In some aspects, a central controller may include logic that is associated with (such as specific to) the mode ID. For example, if the central controller determines to switch between the two parameter sets dynamically (such as without any outside indicator, such as without an indication from a central host or a user interface), the central controller may perform the switch if the two parameter sets are associated with a same mode ID. Otherwise, if the two parameter sets are associated with different mode IDs, the central controller may be unable to perform the switch without receiving an outside indicator. In other words, if the central controller determines to handle a dynamic ISO parameter update itself (such as switch from one parameter set to another parameter set internally without any outside indication), the central controller may switch from a first parameter set to a second parameter set if (such as only if) the first parameter set and the second parameter set are associated with a same mode ID. To switch between parameter sets associated with different mode IDs, the central host indicates a configuration ID to the central controller and the central controller performs an update to the one parameter set that corresponds to the indicated configuration ID.

For example, the central device 205 may create three parameter sets for music and one parameter set for gaming, where the three parameter sets for music may be associated with different configuration IDs but a same first mode ID and the parameter set for gaming may be associated with a different configuration ID and a different second mode ID. As such, the central controller may autonomously switch between any of the three parameter sets for music (because all such parameter sets have a same mode ID), but may not autonomously switch from a parameter set for music to the parameter set for gaming (because such parameter sets have different mode IDs).

Further, each parameter set may include a set of ISO parameters, which may be split between a host portion 245 and a controller portion 250, as illustrated in the context of the parameter set 240-a in the example of the signaling diagram 200. For example, a parameter set may refer to one or more (or all) baseband parameters such that the described protocol supports changes for the one or more (or all) baseband parameters. For example, a parameter set may define, indicate, or provide information indicative of various parameters including an NSE parameter, a BN parameter, an FT parameter, an ISO_Interval parameter, a maxPDU parameter, a PHY parameter, a Subevent_Interval parameter, a Packing_Mode parameter, and the like.

In some aspects, the host portion 245 of, for example, the parameter set 240-a may include a first set of parameters 255 and the controller portion 250 of, for example, the parameter set 240-a may include a second set of parameters 260. In other words, each parameter set may be divided into two separate sets of parameters, with one set being associated with (such as relevant for, applicable to, or usable at) a central host of the central device 205 and the other set being associated with (such as relevant for, applicable to, or usable at) a central controller of the central device 205.

The first set of parameters 255 of the host portion 245 may indicate a parameter set ID value, a mode ID value, a connected ISO group (CIG) ID value, a service data unit (SDU) interval value, a latency value (such as a maximum transport latency (MTL) value), a set of one or more SDU size values (which may be denoted as a set of SDU size[i] values and correspond to a bit rate, where i corresponds to a specific remote device 210), a set of one or more physical layer (PHY) parameters (which may be denoted as a set of PHY[i] values, where i corresponds to a specific remote device 210), a set of one or more real-time network (RTN) values (which may be denoted as a set of RTN[i] values, where i corresponds to a specific remote device 210), or any combination thereof, along with any other parameters that may be relevant for the central host of the central device 205. In some aspects, an MTL value may be indicated by the host (to the controller) and a selected (such as used) parameter set may have a transport latency that is less than or equal to the MTL value. In some aspects, a transport latency may be calculated based on an ISO interval value, an FT value, a BN value, an NSE value, and/or an SDU or PDU size value.

The second set of parameters 260 of the controller portion 250 may indicate an ISO interval value, an FT value, a set of one or more protocol data unit (PDU) size values (which may be denoted as a set of PDU size[i] values, where i corresponds to a specific remote device 210), a set of one more NSE values, a set of one or more BN values (which may be denoted as a set of BN[i] values, where i corresponds to a specific remote device 210), a set of one or more PHY parameters (which may be denoted as a set of PHY[i] values, where i corresponds to a specific remote device 210), a set of one or more sub-event anchor values (which may be denoted as a set of sub-event anchor[i] values, where i corresponds to a specific remote device 210), a set of one or more sub-event interval values (which may be denoted as a set of sub-event interval[i] values, where i corresponds to a specific remote device 210), or any combination thereof, along with any other parameters that may be relevant for the central controller of the central device 205.

As such, the first set of parameters 255 may include the parameter set ID, the mode ID, and a set of application-specific parameters associated with the parameter set 240-a and the second set of parameters 260 may include a set of ISO parameters associated with the parameter set 240-a. In some implementations, the central device 205 may calculate the ISO parameters (such as the second set of parameters 260) based on the set of application-specific parameters of the first set of parameters 255.

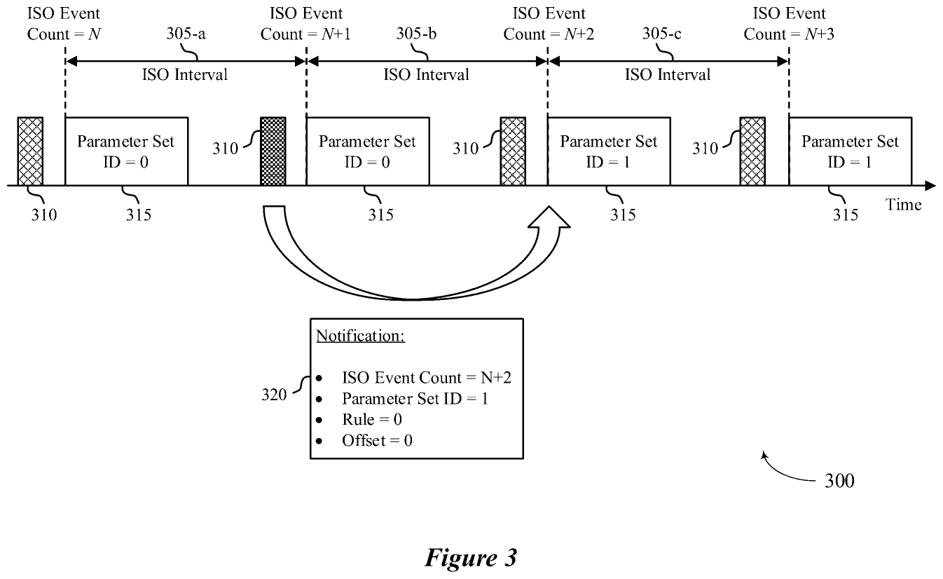

The central device 205 and the remote device 210 may store some (if not all) of such information associated with each of the one or more alternative parameter sets such that both of the central device 205 and the remote device 210 may apply (and communicate thereafter using or otherwise in accordance with) any of such alternative parameter sets dynamically or “on-the-fly” without disconnecting and creating a new ISO link. Additional details relating to such a dynamic or “on-the-fly” update from one parameter set to another parameter set are illustrated and described herein, including by and with reference to FIGS. 3-5.

FIG. 3 shows an example of a communication timeline 300 that supports dynamic ISO parameter updates for BLE communication links according to some aspects of the present disclosure. The communication timeline 300 may implement or be implemented to realize or facilitate aspects of the wireless communication system 100 or the signaling diagram 200. For example, the communication timeline 300 illustrates a dynamic update from an initial parameter set (such as a current parameter set) to another parameter set while a channel associated with an ISO link is active.

The communication timeline 300 may be associated with a set of ISO intervals, such as an ISO interval 305-a, an ISO interval 305-b, and an ISO interval 305-c. Within each ISO interval, one or more wireless communication devices may communicate via at least one of a control channel 310 (which may be understood as an LE link) and a data channel 315 (which may be understood as an ISO link). Communication via a data channel 315 may be in accordance with a specific parameter set, such as in accordance with a specific set of ISO parameters. For example, during the ISO interval 305-a following an ISO event count of N, two or more wireless communication devices (such as the central device 205 and one or more remote devices 210 as illustrated by and described with reference to FIG. 2) may communicate using a first parameter set (such as an initial parameter set) associated with a first parameter set ID (such as a parameter set ID of 0). Such communication may include transmitting or receiving, or both, one or more PDUs using the first parameter set associated with the first parameter set ID.

In some implementations, the central device 205 may detect that the first parameter set may be less suitable as compared to another parameter set (such as another parameter set of one or more alternative parameter sets created by the central device and notified to the one or more remote devices 210) and may transmit, via a control channel 310 of the ISO interval 305-a, a notification 320 of an update from the first parameter set to a second parameter set associated with a second parameter set ID (such as a parameter set ID of 1). For example, the central device 205 may detect or otherwise determine that the second parameter set may be relatively more suitable than the first parameter set based on, for example, new or higher interference or a change in a coexistence scenario at the central device 205. Further, although illustrated and described as being transmitted via a control channel 310, the central device 205 may transmit the notification 320 via any channel, such as a data channel 315.

The notification 320 may include an indication of the second parameter set ID (such as the parameter set ID of 1) and an indication of a time at which the update is to be applied. In some implementations, the notification 320 may provide the indication of the time at which the update is to be applied in terms of (such as in units of or on the basis of) an ISO event count. As illustrated in the example of the notification 320, the time at which the update is to be applied may be when the ISO event count is equal to N+2. As such, the central device 205 may inform one or more remote devices 210 to apply a configuration (such as specific ISO parameter set). Additionally, in some implementations, the notification 320 may include an indication of an offset associated with the time at which the update is to be applied. For example, the offset may be from (such as relative to) the ISO event count indicated by the notification 320 such that the central device 205 and the one or more remote devices 210 may apply (such as perform) the update at a time (such as at a time epoch, at an instant in time, or within a range of time) corresponding to the indicated offset from the indicated ISO event count. In the example of the notification 320, the offset may be equal to 0 and, as such, the time at which the update is to be applied may be at the ISO event count of N+2 (such that, effectively, no offset is applied). In some aspects, the offset may be associated with how the central device 205 indicates where the new link placement is (such as at what time the second parameter set is to be applied).

In some implementations, the notification 320 may include an indication of a flush rule associated with the update that the central device 205 and the one or more remote devices 210 may apply as part of the update to the second parameter set. For example, the central device 205 and the one or more remote devices 210 may support one or more flush rules that are exclusively used to handle transition PDUs and the notification 320 may include an indication of which flush rule of the one or more flush rules is to be used to handle the transition PDUs. In other words, the flush rule indicated via the notification 320 may be different from an original flush rule (such as a default flush rule currently in use), as the flush rule indicated via the notification 320 may be involved specifically to deal with any one or more packets that are generated before the time at which the update is to be performed and have an original flush point after the time at which the update is to be performed. Such one or more packets may be understood as one or more transition PDUs, and a transition PDU may be any PDU that is generated prior to the time at which the update to the second parameter set is to be performed and, in accordance with an initial flush rule associated with the first parameter set, has an original flush point after the time at which the update is to be performed.

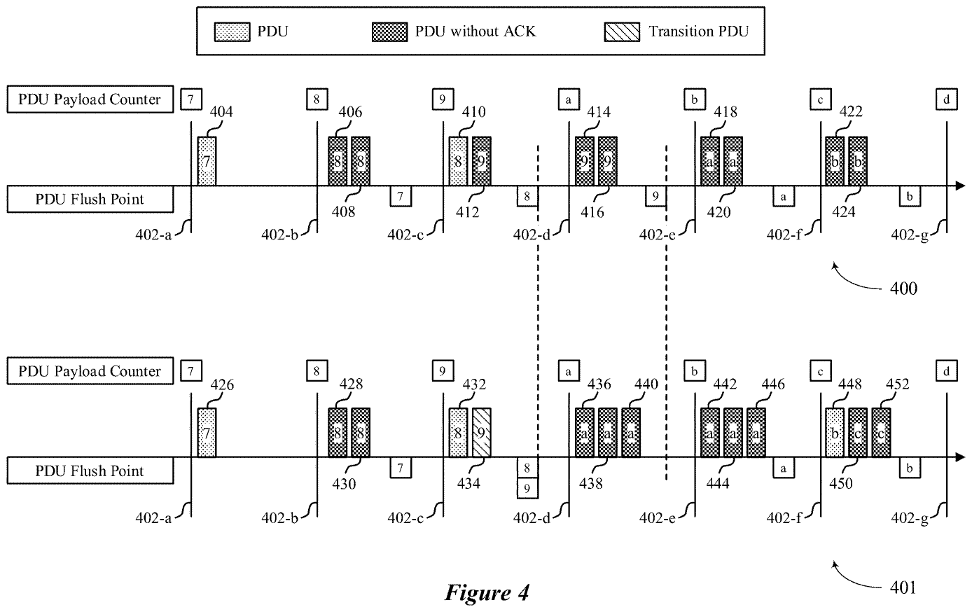

Such an indication of the flush rule may support or otherwise facilitate a scalable flush rule scheme, as the central device 205 may use the described signaling protocol to indicate one of potentially multiple (different) flush rules. As such, the central device 205 may experience scalability as different flush rules are defined and added (which may be associated with increases in wireless device capabilities) without changing a flow of the signaling protocol. The central device 205 and the one or more remote devices 210 may use an indicated flush rule to determine (such as select or identify) when a packet is to be flushed (if an acknowledgment (ACK) has yet to be received for that packet). Additional details relating to such a flush rule associated with a dynamic ISO parameter update are illustrated by and described with reference to FIG. 4.

As such, via the notification 320, the central device 205 may indicate which parameter set (such as which configuration) to apply, when to apply the parameter set, where the new link placement is, and which flush rule is to be used when the update is performed. The central device 205 and the one or more remote devices 210 may communicate via a data channel 315 or a control channel 310, or both, using the first parameter set (associated with the parameter set ID of 0) during the ISO interval 305-b after the ISO event count of N+1 and may perform the update at the ISO event count of N+2 (in accordance with the notification 320). Accordingly, the central device 205 and the one or more remote devices 210 may communicate via a data channel 315 or a control channel 310, or both, using the second parameter set (associated with the parameter set ID of 1) during the ISO interval 305-c after the ISO event count of N+2.

In some implementations, the central device 205 and the one or more remote devices 210 may continue to communicate using the second parameter set until another indication of an update is signaled (such as transmitted by the central device 205 and received at the one or more remote devices 210). In some other implementations, the central device 205 and the one or more remote devices 210 may continue to communicate using the second parameter set for a specific time duration, such as a time duration indicated by the notification 320. Upon expiration of such a specific time duration, the central device 205 and the one or more remote devices 210 may revert to communicating using the first parameter set (which may be a default or initial parameter set).

FIG. 4 shows examples of a communication timeline 400 and a communication timeline 401 that support dynamic ISO parameter updates for BLE communication links according to some aspects of the present disclosure. The communication timeline 400 and the communication timeline 401 may implement or be implemented to realize or facilitate aspects of the wireless communication system 100, the signaling diagram 200, or the communication timeline 300.

The communication timeline 400 illustrates an example timeline in which a dynamic ISO parameter update does not occur and the communication timeline 401 illustrates an example timeline in which a dynamic ISO parameter update does occur, and both the communication timeline 400 and the communication timeline 401 are associated with a PDU payload counter and a PDU flush point. In some aspects, communicating devices may maintain synchronization regarding (such as a mutual understanding of) which data packet is provided at each transmission opportunity (such as at each sub-event) in accordance with maintaining synchronized PDU payload counters and synchronized expectations of PDU flush points.

In some implementations, to facilitate and preserve such synchronization, the central device 205 and the one or more remote devices 210 may implement a same flush rule for any transition PDUs as part of a dynamic update from one parameter set to another parameter. In other words, the central device 205 and the one or more remote devices 210 (such as local and remote devices) may be in-sync and use a same flush rule for the same packet(s) to avoid ambiguity that could result in a link drop (such as a link failure and disconnection). As illustrated by and described with reference to FIG. 3, the central device 205 may indicate the flush rule via the notification 320 of the update to configure the relevant devices to use the same flush rule.

The communication timeline 400 and the communication timeline 401 may be associated with a set of ISO events, including an ISO event 402-a, an ISO event 402-b, an ISO event 402-c, an ISO event 402-d, an ISO event 402-e, an ISO event 402-f, and an ISO event 402-g. In the example of the communication timeline 400 and the communication timeline 401, a PDU payload counter may increment at each ISO event, such that the ISO event 402-a may be associated with a PDU “7,” the ISO event 402-b may be associated with a PDU “8,” the ISO event 402-c may be associated with a PDU “9,” the ISO event 402-d may be associated with a PDU “a,” the ISO event 402-e may be associated with a PDU “b,” the ISO event 402-f may be associated with a PDU “c,” and the ISO event 402-g may be associated with a PDU “d.” In other words, for example, the central device 205 or a remote device 210 may generate a new PDU for transmission at an ISO event interval periodicity.

As illustrated in the example of the communication timeline 400, which may be associated with a parameter set of ISO10, BN=1, FT=2, and NSE=2, a wireless communication device (such as the central device 205 or a remote device 210) may transmit the PDU “7” during an ISO sub-event 404 associated with the ISO event 402-a. In examples in which the wireless communication device receives an ACK associated with (such as responsive to) the PDU “7,” the wireless communication device may transmit the PDU “8” during an ISO sub-event 406 associated with the ISO event 402-b. If the wireless communication device fails to receive an ACK associated with the PDU “8,” the wireless communication device may retransmit the PDU “8” during an ISO sub-event 408. The wireless communication device also may flush the PDU “7” during the ISO interval after the ISO event 402-b, although the wireless communication device may have already discarded the PDU “7” in accordance with the successful transmission of the PDU “7” during the ISO sub-event 404.

If the wireless communication device fails to receive an ACK associated with the retransmission of the PDU “8” during the ISO sub-event 408, the wireless communication device may again attempt to retransmit the PDU “8” during an ISO sub-event 410 associated with the ISO event 402-c. As illustrated in the example of the communication timeline 400, the wireless communication device may receive an ACK associated with the retransmission of the PDU “8” during the ISO sub-event 410 and may transmit a PDU “9” during an ISO sub-event 412. The wireless communication device also may flush the PDU “8” during the ISO interval after the ISO event 402-c, although the wireless communication device may have already discarded the PDU “8” in accordance with the successful transmission of the PDU “8” during the ISO sub-event 410.

If the wireless communication device fails to receive an ACK associated with the PDU “9” transmitted during the ISO sub-event 412, the wireless communication device may retransmit the PDU “9” during an ISO sub-event 414 associated with the ISO event 402-d. If the wireless communication device also fails to receive an ACK associated with the retransmission of the PDU “9” during the ISO sub-event 414, the wireless communication device may again retransmit the PDU “9” during an ISO sub-event 416. In such examples in which the wireless communication device continues to not receive an ACK associated with the PDU “9,” the wireless communication device may flush the PDU “9” after the ISO sub-event 416 and before the ISO event 402-e.

The wireless communication device may transmit a PDU “a” during an ISO sub-event 418 associated with the ISO event 402-e. If the wireless communication device fails to receive an ACK associated with the PDU “a,” the wireless communication device may retransmit the PDU “a” during an ISO sub-event 420. If the wireless communication device continues to not receive an ACK associated with the PDU “a,” the wireless communication device may flush the PDU “a” after the ISO sub-event 420 and before the ISO event 402-f. The wireless communication device may transmit a PDU “b” during an ISO sub-event 422 associated with the ISO event 402-f and, if the wireless communication device fails to receive an ACK associated with the PDU “b,” the wireless communication device may retransmit the PDU “b” during an ISO sub-event 424. If the wireless communication device continues to not receive an ACK associated with the PDU “b,” the wireless communication device may flush the PDU “b” after the ISO sub-event 424 and before the ISO event 402-g.

As illustrated in the example of the communication timeline 400, which may be associated with a first parameter set of ISO10, BN=1, FT=2, and NSE=2 for a first period of time and a dynamic update to a second parameter set of ISO10, BN=1, FT=2, and NSE=3 for a second period of time, a wireless communication device (such as the central device 205 or a remote device 210) may transmit a PDU “7” during an ISO sub-event 426 associated with the ISO event 402-a. In examples in which the wireless communication device receives an ACK associated with (such as responsive to) the PDU “7,” the wireless communication device may transmit the PDU “8” during an ISO sub-event 428 associated with the ISO event 402-b. If the wireless communication device fails to receive an ACK associated with the PDU “8,” the wireless communication device may retransmit the PDU “8” during an ISO sub-event 430. The wireless communication device also may flush the PDU “7” during the ISO interval after the ISO event 402-b, although the wireless communication device may have already discarded the PDU “7” in accordance with the successful transmission of the PDU “7” during the ISO sub-event 426.

If the wireless communication device fails to receive an ACK associated with the retransmission of the PDU “8” during the ISO sub-event 430, the wireless communication device may again attempt to retransmit the PDU “8” during an ISO sub-event 432 associated with the ISO event 402-c. As illustrated in the example of the communication timeline 401, the wireless communication device may receive an ACK associated with the retransmission of the PDU “8” during the ISO sub-event 432 and may transmit a PDU “9” during an ISO sub-event 434. In some implementations, the wireless communication device may perform a dynamic update from the first parameter set (ISO10, BN=1, FT=2, and NSE=2) to the second parameter set (ISO10, BN=1, FT=2, and NSE=3) at the ISO event 402-d. For example, the wireless communication may transmit or receive the notification 320 and the notification 320 may indicate that the wireless communication device is to apply the second parameter set starting at the ISO event 402-d.

In some implementations, the notification 320 may indicate a flush rule associated with the update to the second parameter set at the ISO event 402-d. Further, although described as being conveyed via the notification 320, the wireless communication device may alternatively transmit or receive an indication of the flush rule associated with the update via separate signaling or messaging, and/or may retrieve the flush rule associated with the update from a memory of the wireless communication device (such as if one or more flush rules associated with, such as dedicated for, dynamic ISO parameter set updates are statically configured). In accordance with the flush rule associated with the update to the second parameter set, the wireless communication device may set a flush point for the PDU “9” (which may be understood or referred to as a transition PDU) to occur prior to the ISO event 402-d.

For example, the wireless communication device may flush any transition PDUs (including the PDU “9”) during a final ISO interval prior to the time at which the update is to be performed and the second parameter set is to be applied. In other words, in accordance with this example flush rule, any packet generated prior to an indicated time instant (at which point the update is to be performed) may be flushed regardless of whether an original flush point of that packet is in the future of the indicated time instant or not. Likewise, in accordance with this example flush rule, since the instant, the wireless communication device may transmit a new packet having a maximum retransmission opportunity that may not be used by a previous packet. In the example of the communication timeline 401, the wireless communication device may flush the PDU “9” at the same time as the PDU “8.” In some aspects, in accordance with the update, a flush point for PDU “0” may be moved back (in time) and an SDU synchronization reference for PDU “9” may remain the same. Alternatively, the flush rule may indicate that a transition PDU is allowed to be retransmitted past the time at which the update occurs. Such a flush rule may be useful when switching between parameter sets associated with a same application or traffic type (such as switching between different parameter sets associated with music streaming).

The wireless communication device may perform the update and apply the second parameter set starting at the ISO event 402-d and, in the example of the communication timeline 401, may attempt to transmit (and retransmit) a PDU “a” during each of an ISO sub-event 436, an ISO sub-event 438, an ISO sub-event 440, an ISO sub-event 442, an ISO sub-event 444, and an ISO sub-event 446 before flushing the PDU “a” prior to the ISO event 402-f. In accordance with flushing the PDU “a” prior to the ISO event 402-f, the wireless communication device may transmit a PDU “b” during an ISO sub-event 448 associated with the ISO event 402-f and, if the wireless communication device receives an ACK associated with the PDU “b,” the wireless communication device may transmit a PDU “c” during an ISO sub-event 450. In the example of the communication timeline 401, the wireless communication device may fail to receive an ACK associated with the PDU “c” and may retransmit the PDU “c” during an ISO sub-event 452.

As illustrated by and described with reference to the communication timeline 401, the wireless communication device may perform a dynamic update from one parameter set (associated with one set of ISO parameters) to another parameter set (associated with another set of ISO parameter) while actively communicating data and without disconnecting an ISO link. In other words, the wireless communication device may perform the update while a channel associated with an ISO link is active, which may reduce latency, reduce glitching, and provide a more consistent and better overall user experience as a result of such lower latency and fewer glitches.

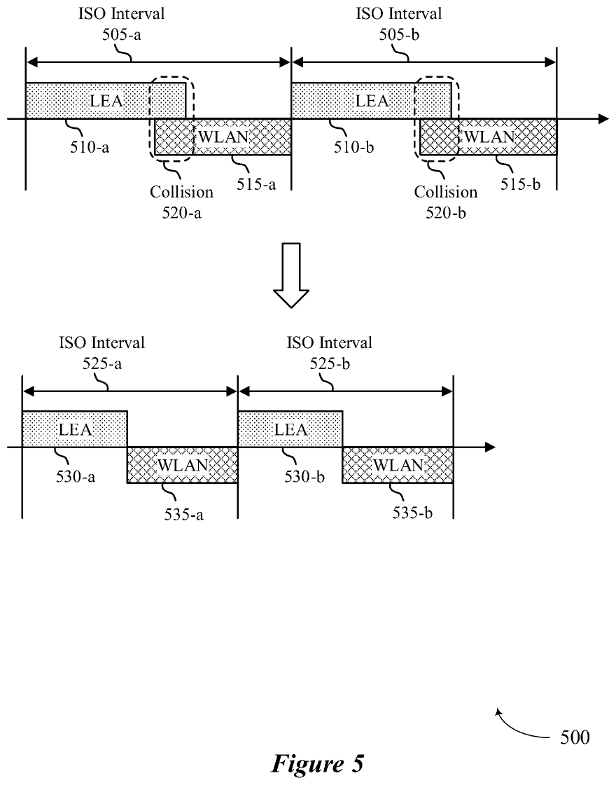

FIG. 5 shows an example of an ISO parameter update 500 that supports dynamic ISO parameter updates for BLE communication links according to some aspects of the present disclosure. The ISO parameter update 500 may implement or be implemented to realize or facilitate aspects of the wireless communication system 100, the signaling diagram 200, the communication timeline 300, the communication timeline 400, and the communication timeline 401. For example, one or more wireless communication devices (such as a central device 205 and one or more remote devices 210) may switch from a first parameter set to a second parameter set in accordance with detecting a change in an RF environment, such as a change to one or more communication parameters associated with a wireless communication link of a second wireless communication technology (such as Wi-Fi) different from a first wireless communication technology (such as Bluetooth) associated with the ISO link. In other words, the ISO parameter update 500 may illustrate how some aspects of the present disclosure may be implemented in accordance with a coexistence engine utilizing the protocol (such that a dynamic parameter update may be per coexistence request).

For example, a central device 205 may initially communicate with one or more remote devices 210 in accordance with the first parameter set, which may be associated with a first ISO interval duration defining an ISO interval 505-a and an ISO interval 505-b. The first parameter set may further be associated with low energy audio (LEA) communication during a time period 510-a and a time period 510-b. In some aspects, one or more other wireless communication devices of a WLAN may communicate during a time period 515-a and a time period 515-b, which may be associated with a collision 520-a (such as an overlap in time) between the time period 510-a and the time period 515-a and a collision 520-b (such as an overlap in time) between the time period 510-b and the time period 515-b.

In some implementations, the central device 205 may detect the interference from the WLAN communication and may trigger a dynamic ISO parameter update to switch from the first parameter set to a second parameter set, which may be associated with a second ISO interval duration defining an ISO interval 525-a and an ISO interval 525-b. The second parameter set may further be associated with LEA communication during a time period 530-a and a time period 530-b, which may avoid overlapping in time with a time period 535-a and a time period 535-b during which WLAN communication may occur.

Additionally, or alternatively, the ISO parameter update 500 may be illustrative of a switch from a first Wi-Fi mode in which Wi-Fi communication may be associated with relatively longer or more relaxed latency targets to a second Wi-Fi mode in which Wi-Fi communication may be associated with relatively shorter or more stringent latency targets, and a corresponding dynamic update from the first parameter set to the second parameter set to avoid the time period 535-a and the time period 535-b during which low latency Wi-Fi communication is expected or likely. As such, the central device 205 and the one or more remote devices 210 may support or otherwise provide better coexistence performance via a dynamic request to change ISO parameters (such as ISO interval duration and/or bandwidth) and a corresponding update of the ISO parameters without tearing down the ISO link.

In some implementations, an initiator of the ISO parameter update 500 may be the component that detects the situation that warrants the change in parameter set. For example, if a coexistence engine (of the central device 205) detects interference or a change in a Wi-Fi mode, the coexistence engine may initiate the ISO parameter update 500. For further example, a Bluetooth controller (such as a central controller of the central device 205) may detect an RF environment change (such as a worsening or deteriorating RF environment) that may increase the likelihood of an audio glitch and the Bluetooth controller may determine or otherwise decide to initiate a change to a more robust ISO configuration accordingly. In such an example, the Bluetooth controller may detect the RF environment change during, for example, music streaming. For further example, a host (such as a central host of the central device 205) may initiate the update in accordance with an opening or closing of one or more applications at the central device. For instance, during music streaming, a user may open a gaming application and the host may initiate an update from a first ISO configuration (such as an ISO configuration associated with, specific to, or otherwise adapted to music) to a second ISO configuration (such as an ISO configuration associated with, specific to, or otherwise adapted to gaming) accordingly.

FIG. 6 shows an example of a process flow 600 that supports dynamic ISO parameter updates for BLE communication links according to some aspects of the present disclosure. The process flow 600 may implement or be implemented to realize aspects of the wireless communication system 100, the signaling diagram 200, the communication timeline 300, the communication timeline 400, the communication timeline 401, and the ISO parameter update 500. A central host 605 of, for example, the central device 205 and a central controller 610 of the central device 205 may exchange messaging as illustrated by the process flow 600 to create one or more alternative parameter sets (such as one or more alternative configurations) of an ISO link (such as the communication link 215) in advance.

In the following description of the process flow 600, the operations may be performed (such as reported or provided) in a different order than the order shown, or the operations performed by the example devices may be performed in different orders or at different times. For example, specific operations also may be left out of the process flow 600, or other operations may be added to the process flow 600. Further, although some operations or signaling may be shown to occur at different times for discussion purposes, these operations may actually occur at the same time.

At 615, the central host 605 may transmit, to the central controller 610, a request to create a first parameter set (such as parameter set #1).

At 620, the central controller 610 may transmit, to the central host 605, a response to the request to create the first parameter set. The response may include an accept indication for the first parameter set or a reject indication for the first parameter set. In examples in which the response is an accept indication, the central device 205 may create the first parameter set and store information associated with the first parameter set (for potential use in a dynamic update of an ISO link during subsequent communication with one or more remote devices 210). In examples in which the response is a reject indication, the central device 205 may refrain from creating the first parameter set and/or may discard information associated with the first parameter set (such that the first parameter set is not an option for a dynamic update of an ISO link during subsequent communication with one or more remote devices 210).

At 625, the central host 605 may transmit, to the central controller 610, a request to create a second parameter set (such as parameter set #2).

At 630, the central controller 610 may transmit, to the central host 605, a response to the request to create the second parameter set. The response may include an accept indication for the second parameter set or a reject indication for the second parameter set. In examples in which the response is an accept indication, the central device 205 may create the second parameter set and store information associated with the second parameter set (for potential use in a dynamic update of an ISO link during subsequent communication with one or more remote devices 210). In examples in which the response is a reject indication, the central device 205 may refrain from creating the second parameter set and/or may discard information associated with the second parameter set (such that the second parameter set is not an option for a dynamic update of an ISO link during subsequent communication with one or more remote devices 210).

The central host 605 and the central controller 610 may similarly create any quantity of parameter sets for potential use in a dynamic update of an ISO link during subsequent communication with one or more remote devices 210, and such a creation of one or more parameter sets may be understood as the central device 205 creating one or more alternative parameter sets (such as alternative ISO link configurations) in advance. For example, as illustrated in the example of the process flow 600, at 635, the central host 605 may transmit a request to create a parameter set #X and, at 640, the central controller may transmit a response (an accept indication or a reject indication) to the request to create the parameter set #X. As described herein, X may be representative of how many alternative parameter sets the central device 205 creates, and X may be 1, 2, 3, 4, 5, 6, or any other number.

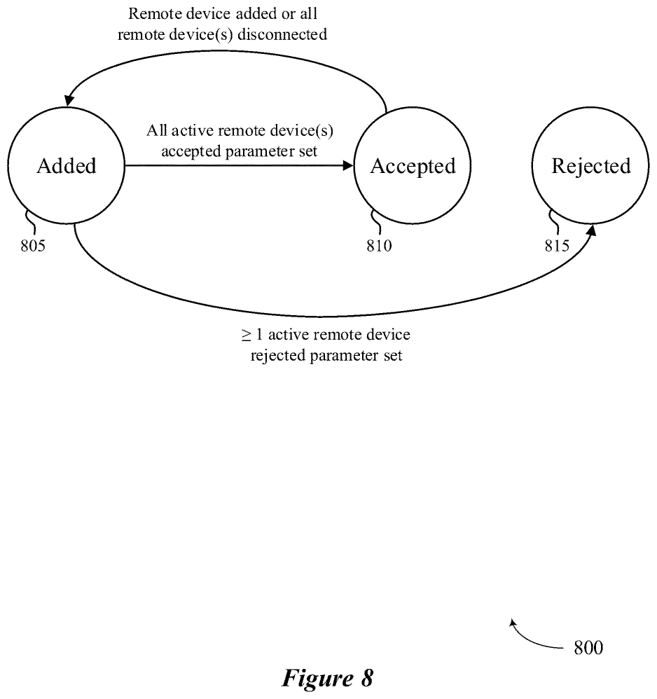

In accordance with creating the one or more alternative parameter sets, the central device 205 may notify one or more remote devices 210 of each of the one or more alternative parameter sets. A remote device 210 may accept or reject an alternative parameter set and, as such, the central device 205 may use the notification process between the central device 205 and the remote device(s) 210 to identify, determine, or otherwise ascertain which alternative parameter set(s) will be supported by the remote device(s) 210. Additional details relating to such a notification process are illustrated by and described with reference to FIGS. 7 and 8.

FIG. 7 shows an example of a process flow 700 that supports dynamic ISO parameter updates for BLE communication links according to some aspects of the present disclosure. The process flow 700 may implement or be implemented to realize aspects of the wireless communication system 100, the signaling diagram 200, the communication timeline 300, the communication timeline 400, the communication timeline 401, the ISO parameter update 500, and the process flow 600. For example, in accordance with the process flow 700, the central device 205 may notify one or more remote devices 210, such as a remote device 210-a and a remote device 210-b, of one or more alternative parameter sets and may leverage such notifications to perform one or more dynamic ISO parameter updates.

In the following description of the process flow 700, the operations may be performed (such as reported or provided) in a different order than the order shown, or the operations performed by the example devices may be performed in different orders or at different times. For example, specific operations also may be left out of the process flow 700, or other operations may be added to the process flow 700. Further, although some operations or signaling may be shown to occur at different times for discussion purposes, these operations may actually occur at the same time.

At 705, the central device 205 may notify the remote device 210-a of a first parameter set (such as a parameter set #1). In other words, the central device 205 may transmit information associated with the first parameter set to the remote device 210-a. Such information may include indication(s) of each of the parameter(s) associated with (or that define) the first parameter set. For example, the information associated with the first parameter set may include one or more (or all) parameters from a host portion 245 of the first parameter set or one or more (or all) parameters from a controller portion 250 of the first parameter set, or any combination of parameters from a host portion 245 and a controller portion 250 of the first parameter set. In some implementations, some parameters of the first parameter set may be specific to a given remote device i. In some implementations, the central device 205 may notify the remote device 210-a of a single value of a parameter in accordance with an ID i₁ associated with the remote device 210-a. In some other examples, the central device 205 may notify the remote device 210-a of a set of multiple values of a parameter and the remote device 210-a may select or identify which value of the set of multiple values is applicable to the remote device 210-a in accordance with an ID i₁ associated with the remote device 210-a.

At 710, the remote device 210-a may transmit, to the central device 205, a response to the notification of the first parameter set. The response may be an accept indication, which the remote device 210-a may transmit if the remote device 210-a is capable of operating using (such as operating in accordance with) the first parameter set, or a rejection indication, which the remote device 210-a may transmit if the remote device 210-a is incapable of operating using (such as operating in accordance with) the first parameter set. Such a capability relating to whether the remote device 210-a is able to operate in accordance with a given parameter set may be associated with a device capability (such as a memory, transceiver, or processor capability of the remote device 210-a).

At 715, the central device 205 may notify the remote device 210-b of the first parameter set (such as the parameter set #1). In other words, the central device 205 may transmit information associated with the first parameter set to the remote device 210-b. Such information may include indication(s) of each of the parameter(s) associated with (or that define) the first parameter set. For example, the information associated with the first parameter set may include one or more (or all) parameters from a host portion 245 of the first parameter set or one or more (or all) parameters from a controller portion 250 of the first parameter set, or any combination of parameters from a host portion 245 and a controller portion 250 of the first parameter set. In some implementations, some parameters of the first parameter set may be specific to a given remote device i. In some implementations, the central device 205 may notify the remote device 210-b of a single value of a parameter in accordance with an ID i₂ associated with the remote device 210-b. In some other examples, the central device 205 may notify the remote device 210-b of a set of multiple values of a parameter and the remote device 210-b may select or identify which value of the set of multiple values is applicable to the remote device 210-b in accordance with an ID i₂ associated with the remote device 210-b. In some aspects, for a given parameter, the parameter may be associated with a first value applicable to the remote device 210-a (in accordance with an ID i₁) and a second (different) value applicable to the remote device 210-b (in accordance with an ID i₂).

At 720, the remote device 210-b may transmit, to the central device 205, a response to the notification of the first parameter set. The response may be an accept indication, which the remote device 210-b may transmit if the remote device 210-b is capable of operating using (such as operating in accordance with) the first parameter set, or a rejection indication, which the remote device 210-b may transmit if the remote device 210-b is incapable of operating using (such as operating in accordance with) the first parameter set. Such a capability relating to whether the remote device 210-b is able to operate in accordance with a given parameter set may be associated with a device capability (such as a memory, transceiver, or processor capability of the remote device 210-b).

The central device 205 may notify each of the remote device 210-a and the remote device 210-b of each of the one or more alternative parameter sets created by the central device 205. In other words, the central device 205 may transmit information associated with the one or more parameter sets to the remote device 210-a and the remote device 210-b. For example, as illustrated by the example of the process flow 700, at 725, the central device 205 may notify the remote device 210-a of a parameter set #X and, at 730, the remote device 210-a may transmit a response (such as an accept indication or a reject indication) to the notification of the parameter set #X. At 735, the central device 205 may notify the remote device 210-b of the parameter set #X and, at 740, the remote device 210-b may transmit a response (such as an accept indication or a reject indication) to the notification of the parameter set #X.

The central device 205 may track for which of the one or more parameter sets accept indications are received (such as received from both the remote device 210-a and the remote device 210-b) and for which of the one or more parameter sets at least one reject indication is received (such as from one or both of the remote device 210-a and the remote device 210-b). For example, the central device 205 may store information indicative of parameter sets that both the remote device 210-a and the remote device 210-b accept and may discard (or otherwise refrain from using, at least with the remote device 210-a and the remote device 210-b) information indicative of parameter sets that at least one of the remote device 210-a and the remote device 210-b reject. Accordingly, when communicating with the remote device 210-a and the remote device 210-b, the central device 205 may transmit or receive data packets and, based on changing data traffic and/or changing link conditions, indicate or otherwise trigger a dynamic parameter set update such that the update is to a parameter set that is accepted by both the remote device 210-a and the remote device 210-b. In other words, the central device 205 may notify the configurations (such as parameter sets) to one or more remote devices 210 in advance, each remote device 210 can choose to accept or reject the configuration, and a configuration may not be used if the configuration has been rejected by any of the one or more remote devices 210. Additional details associated with such notification and acceptance/rejection are illustrated by and described with reference to FIG. 8.

For example, at 745, the central device 205 may transmit one or more data packets to and/or receive one or more data packets from the remote device 210-a. In some implementations, the central device 205 and the remote device 210-a may communicate (such as transmit and/or receive) using an initial (such as current or default) parameter set.

At 750, the central device 205 may transmit one or more data packets to and/or receive one or more data packets from the remote device 210-b. In some implementations, the central device 205 and the remote device 210-b may communicate (such as transmit and/or receive) using the initial parameter set. In the course of communication, the central device 205 may identify, ascertain, measure, or otherwise determine that the initial parameter set is no longer suitable (based on or otherwise in accordance with changing data traffic, a changing coexistence scenario, and/or changing link conditions). In some implementations, the central device 205 may determine that the initial parameter set is no longer suitable in accordance with one or more link quality metrics (such as in accordance with one or more link quality metrics failing to satisfy a threshold). Additionally, or alternatively, one or both of the remote device 210-a and the remote device 210-b may provide feedback and/or suggestions to the central device 205 to assist the central device 205 in determining whether the initial parameter set is suitable. In some aspects, such a suggestion may include an indication, from one or both of the remote device 210-a and the remote device 210-b, of a parameter set to which an update is recommended. Additionally, or alternatively, one or both of the remote device 210-a and the remote device 210-b may identify, ascertain, measure, or otherwise determine that the initial parameter set is no longer suitable. In such implementations, one or both of the remote device 210-a and the remote device 210-b may transmit a request to the central device 205 to trigger an update from the initial parameter set to another parameter set. If a remote device 210 provides such feedback, suggestion, and/or request, the remote device 210 may transmit or direct the feedback, suggestion, and/or request to a host or controller of the central device 205 and the host or controller may trigger the update accordingly.

At 755, the central device 205 may transmit, to the remote device 210-a, an indication of an update from the initial parameter set to a first parameter set (such as a first parameter set of a set of parameter sets accepted by both the remote device 210-a and the remote device 210-b). At 760, the remote device 210-a may transmit an ACK associated with the indication of the update. At 765, the central device 205 may transmit, to the remote device 210-b, an indication of the update from the initial parameter set to the first parameter set. At 770, the remote device 210-b may transmit an ACK associated with the indication of the update. In some implementations, the central device 205 may transmit the indications of the update via a notification 320 (or via multiple notifications 320), as illustrated by and described in more detail with reference to FIG. 3. The indications of the update may indicate a configuration ID associated with the first parameter set, a time at which the update is to occur (which may be understood or referred to as an “instant”), a flush rule associated with the update, and/or an offset associated with when the update is to occur.

At 775, the central device 205, the remote device 210-a, and the remote device 210-b may detect that the time at which the update is to occur arrives (in accordance with the indicated “instant” and any offset associated with when the update is to occur). The central device 205, the remote device 210-a, and the remote device 210-b may perform the update to the first parameter set accordingly and begin communicating using the first parameter set thereafter.

At 780, the central device 205 may transmit one or more data packets to and/or receive one or more data packets from the remote device 210-a. In some implementations, the central device 205 and the remote device 210-a may communicate (such as transmit and/or receive) using the first parameter set (such as the new configuration) in accordance with the indication of the update to the first parameter set indicated at 755. At 785, the central device 205 may transmit one or more data packets to and/or receive one or more data packets from the remote device 210-b. In some implementations, the central device 205 and the remote device 210-b may communicate (such as transmit and/or receive) using the first parameter set (such as the new configuration) in accordance with the indication of the update to the first parameter set indicated at 765. As such, the central device 205, the remote device 210-a, and the remote device 210-b may dynamically switch from using one set of ISO parameters to using another set of ISO parameters without link disconnection, which may reduce latency, increase data rates and reliability, and likewise improve a user experience.

FIG. 8 shows an example of a parameter set tracking diagram 800 that supports dynamic ISO parameter updates for BLE communication links according to some aspects of the present disclosure. The parameter set tracking diagram 800 may implement or be implemented to facilitate or realize aspects of the wireless communication system 100, the signaling diagram 200, the communication timeline 300, the communication timeline 400, the communication timeline 401, the ISO parameter update 500, the process flow 600, and the process flow 700. For example, a central device 205 may track, sort, or otherwise differentiate parameter sets in accordance with whether a parameter set is accepted by all remote devices 210 or rejected by at least one remote device 210. As described herein, a remote device 210 may be equivalently referred to or understood as a peripheral or a peripheral device.

At 805, the central device 205 may receive an indication, identify, or otherwise determine that a remote device 210 is added (to a set of remote devices served by the central device 205) or that all remote devices 210 have disconnected, which may trigger a transmission, by the central device 205 to the added remote device(s) 210 or to a new set of remote devices 210, of information associated with one or more parameter sets of an ISO link between the central device 205 and the remote device(s) 210. Each remote device 210 may receive the information associated with the one or more parameter sets of the ISO link and, in response, may transmit an accept indication or a rejection indication in accordance with a capability of that remote device 210.

At 810, if all active remote device(s) 210 provide accept indications for a given parameter set, the central device 205 may select or otherwise designate that parameter set as an “accepted” parameter set. The central device 205 may dynamically request an update to any parameter set selected or designated as an “accepted” parameter set. At 815, if at least one remote device 210 provides a reject indication for a given parameter set, the central device 205 may select or otherwise designate that parameter set as a “rejected” parameter set. The central device 205 may refrain from dynamically requesting an update to any parameter set selected or designated as a “rejected” parameter set.

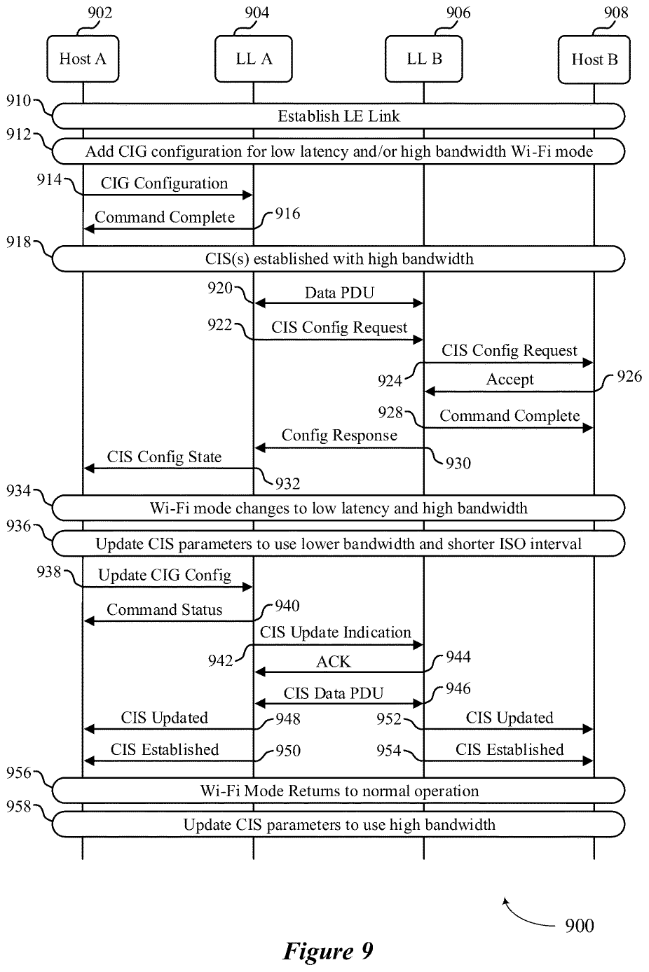

FIG. 9 shows an example of a process flow 900 that supports dynamic ISO parameter updates for BLE communication links according to some aspects of the present disclosure. The process flow 900 may implement or be implemented to facilitate or realize aspects of the wireless communication system 100, the signaling diagram 200, the communication timeline 300, the communication timeline 400, the communication timeline 401, the ISO parameter update 500, the process flow 600, the process flow 700, and the parameter set tracking diagram 800. For example, a central device 205 and a remote device 210, or components thereof, may communicate in accordance with the process flow 900 to dynamically update a parameter set of an ISO link between the central device 205 and the remote device 210. For example, the process flow 900 illustrates communication between a first host 902 (such as a host A), an LL component 904 (such as an LL A), a LL component 906 (such as an LL B), and a second host 908 (such as a host B). The first host 902 and the LL component 904 may be components of a first wireless communication device and the second host 908 and the LL component 906 may be components of a second wireless communication device.

In the following description of the process flow 900, the operations may be performed (such as reported or provided) in a different order than the order shown, or the operations performed by the example devices may be performed in different orders or at different times. For example, specific operations also may be left out of the process flow 900, or other operations may be added to the process flow 900. Further, although some operations or signaling may be shown to occur at different times for discussion purposes, these operations may actually occur at the same time.

At 910, the first wireless communication device and the second wireless communication device may establish a communication link. In some implementations, the communication link may be a Bluetooth link, such as an LE or a BLE link. In some aspects, the first wireless communication device and the second wireless communication device may establish the communication link when a Wi-Fi mode (such as a WLAN mode) is normal, which may be understood as when a Wi-Fi mode is associated with a first latency target and/or a first bandwidth. In some aspects, the first wireless communication device and the second wireless communication device may communicate using an initial parameter set in accordance with establishing the communication link.

At 912, the first wireless communication device and the second wireless communication device may add a CIG configuration for low latency and/or high bandwidth Wi-Fi mode. For example, the first wireless communication device and the second wireless communication device may configure a first parameter set, and the first parameter set may be adapted for a low latency and/or high bandwidth Wi-Fi mode.

At 914, the first host 902 may transmit an indication of a CIG configuration. In some aspects, the first host 902 may transmit the indication of the CIG configuration to the LL component 904 via an HCI_VS_LE_Add_Configuration message.

At 916, the LL component 904 may transmit a command complete indication. In some aspects, the LL component 904 may transmit the command complete indication to the first host 902 via an HCI_Command_Complete message.

At 918, the first wireless communication device and the second wireless communication device may establish one or more CISs with a relatively high bandwidth. For example, in accordance with the Wi-Fi mode being associated with the first latency target and/or the first bandwidth, the first wireless communication device and the second wireless communication device may establish one or more CISs to use a relatively large bandwidth (as some of such bandwidth may have gone unused by Wi-Fi communication).

At 920, the LL component 904 and the LL component 906 may communicate (such as transmit and/or receive) one or more data packets (such as one or more data PDUs). For example, the LL component 904 and the LL component 906 may communicate one or more CIS data PDUs.

At 922, the LL component 904 may transmit a CIG configuration request to the LL component 906. In some aspects, the LL component 904 may transmit the CIG configuration request via a QLL_CIS_CONFIG_REQ message.

At 924, the LL component 906 may transmit (such as relay or forward) the CIG configuration request to the second host 908. In some aspects, the LL component 906 may transmit a relayed or forwarded version of the CIG configuration request via a HCI_VS_LE_CIS_Config_Request message.

At 926, the second host 908 may transmit an accept indication to the LL component 906. In some aspects, the second host 908 may transmit the accept indication via an HCI_VS_LE_Accept-CIS_Config_Request message.

At 928, the LL component 906 may transmit a command complete indication to the second host 908. In some aspects, the LL component 906 may transmit the command complete indication via an HCI_Command_Complete message.

At 930, the LL component 906 may transmit a configuration response to the LL component 904. In some aspects, the LL component 906 may transmit the configuration response via a QLL_CIS_CONFIG_RSP message.

At 932, the LL component 904 may transmit an indication of a CIS configuration state to the first host 902. In some aspects, the LL component 904 may transmit the indication of the CIS configuration state via an HCI VS LE CIS Configuration State message.

At 934, one or both of the first wireless communication device and the second wireless communication device may detect that the Wi-Fi-mode changes to low latency (such as ultra-low latency) and/or high bandwidth. In other words, the first wireless communication device or the second wireless communication device may detect that Wi-Fi communication switches from the first latency target and/or the first bandwidth to a second latency target and/or a second bandwidth, where the second latency target is relatively more stringent than the first latency target and the second bandwidth is larger than the first bandwidth.

At 936, the first wireless communication device and the second wireless communication device may initiate a signaling exchange to update CIS parameters to use lower bandwidth and/or a shorter ISO interval (to avoid interfering with the Wi-Fi communication).

At 938, the first host 902 may transmit an indication to update a CIG configuration to the LL component 904. In some aspects, the first host 902 may transmit the indication to update the CIG configuration via an HCI_VS_LE_Update CIG_Configuration message.

At 940, the LL component 904 may transmit a command status indication to the first host 902. In some aspects, the LL component 904 may transmit the command status indication via an HCI_Command Status message.

At 942, the LL component 904 may transmit a CIS update indication to the LL component 906. In some aspects, the LL component 904 may transmit the CIS update indication via a QLL_CIS_UPDATE_IND message.

At 944, the LL component 906 may transmit an ACK to the LL component 904.

At 946, the LL component 904 and the LL component 906 may communicate (such as transmit and/or receive) one or more data packets. For example, the LL component 904 and the LL component 906 may communicate one or more CIS data PDUs.

At 948, the LL component 904 may transmit a CIS updated indication to the first host 902. In some aspects, the LL component 904 may transmit the CIS updated indication via a HCI_VS_LE_CIS_Updated message.

At 950, the LL component 904 may transmit a CIS established indication to the first host 902. In some aspects, the LL component 904 may transmit the CIS established indication via an HCI_LE_CIS_Established message.

At 952, the LL component 906 may transmit a CIS updated indication to the second host 908. In some aspects, the LL component 906 may transmit the CIS updated indication via a HCI_VS_LE_CIS_Updated message.

At 954, the LL component 906 may transmit a CIS established indication to the second host 908. In some aspects, the LL component 906 may transmit the CIS established indication via an HCI_LE_CIS_Established message.

At 956, one or both of the first wireless communication device and the second wireless communication device may detect that the Wi-Fi-mode returns to a normal operation. In other words, the first wireless communication device or the second wireless communication device may detect that Wi-Fi communication switches from the second latency target and/or the second bandwidth to the first latency target and/or the first bandwidth.

At 958, the first wireless communication device and the second wireless communication device may initiate a signaling exchange to update CIS parameters to use higher bandwidth and/or a longer ISO interval (as there may be more available bandwidth in accordance with the Wi-Fi mode returning to the normal operation). Such a signaling exchange may be similar to the signaling exchange described between 938 and 954, inclusive.

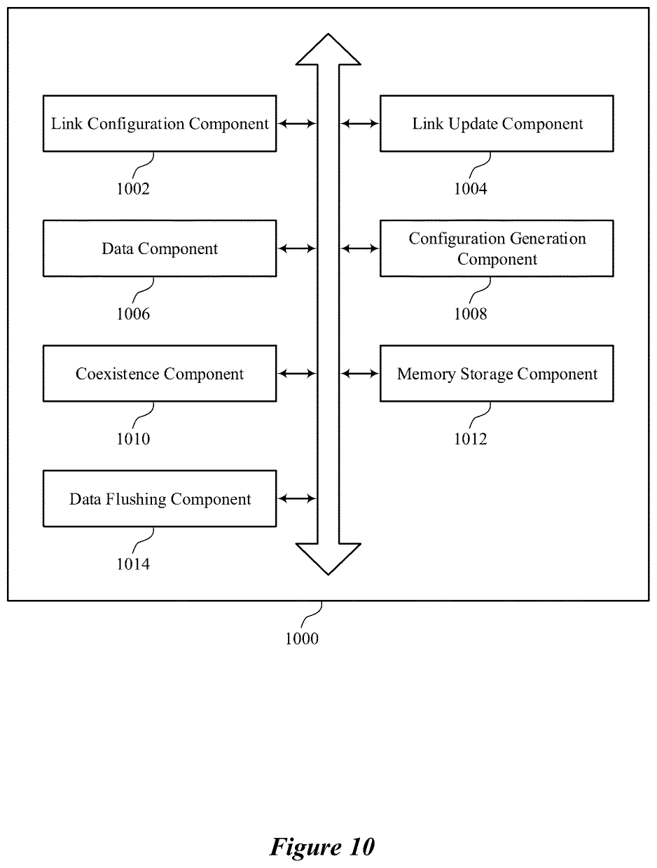

FIG. 10 shows a block diagram of an example wireless communication device 1000 that supports dynamic ISO parameter updates for BLE communication links according to some aspects of the present disclosure. The wireless communication device 1000 may be an example of a central device 205 or a remote device 210 as described herein. In various examples, the wireless communication device 1000 can be a chip, SoC, chipset, package or device that may include: one or more modems; one or more processors, processing blocks or processing elements (collectively “at least one processor”); one or more radios (collectively “at least one radio”); and one or more memories or memory blocks (collectively “at least one memory”). In some implementations, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some implementations, the wireless communication device 1000 also includes or can be coupled with at least one application processor which may be further coupled with at least one memory. In some implementations, the wireless communication device 1000 further includes a user interface (such as a touchscreen or keypad) and a display, which may be integrated with the UI to form a touchscreen display. In some implementations, the wireless communication device 1000 may further include one or more sensors such as, for example, one or more inertial sensors, accelerometers, temperature sensors, pressure sensors, or altitude sensors.

The wireless communication device 1000, or various components thereof, may be an example of means for performing various aspects of dynamic ISO parameter updates for BLE communication links as described herein. For example, the wireless communication device 1000 may include a link configuration component 1002, a link update component 1004, a data component 1006, a configuration generation component 1008, a coexistence component 1010, a memory storage component 1012, a data flushing component 1014, or any combination thereof. Each of these components may communicate, directly or indirectly, with one another (such as via one or more buses). Portions of one or more of the link configuration component 1002, the link update component 1004, the data component 1006, the configuration generation component 1008, the coexistence component 1010, the memory storage component 1012, and the data flushing component 1014 may be implemented at least in part in hardware or firmware, by at least one modem, by at least one processor and as software stored in at least one memory, or as non-transitory instructions (or “code”) executable by the at least one processor to perform the functions or operations of the respective module.

In some implementations, the at least one processor may be a component of a processing system. A processing system may generally refer to a system or series of machines or components that receives inputs and processes the inputs to produce a set of outputs (which may be passed to other systems or components of, for example, the wireless communication device 1000). For example, a processing system of the wireless communication device 1000 may refer to a system including the various other components or subcomponents of the wireless communication device 1000, such as the at least one processor, or at least one transceiver, or at least one communications manager, or other components or combinations of components of the wireless communication device 1000. The processing system of the wireless communication device 1000 may interface with other components of the wireless communication device 1000, and may process information received from other components (such as inputs or signals) or output information to other components. For example, a chip or modem of the wireless communication device 1000 may include a processing system, a first interface to output information and a second interface to obtain information. In some implementations, the first interface may refer to an interface between the processing system of the chip or modem and a transmitter, such that the wireless communication device 1000 may transmit information output from the chip or modem. In some implementations, the second interface may refer to an interface between the processing system of the chip or modem and a receiver, such that the wireless communication device 1000 may obtain information or signal inputs, and the information may be passed to the processing system. A person having ordinary skill in the art will readily recognize that the first interface also may obtain information or signal inputs, and the second interface also may output information or signal outputs.

The wireless communication device 1000 may support wireless communication performable at a first wireless communication device in accordance with examples as disclosed herein. The link configuration component 1002 is capable of, configured to, or operable to support a means for transmitting information associated with one or more parameter sets of an ISO communication link between the first wireless communication device and at least a second wireless communication device. In some implementations, the link configuration component 1002 is capable of, configured to, or operable to support a means for receiving an accept indication associated with at least a first parameter set of the one or more parameter sets. The link update component 1004 is capable of, configured to, or operable to support a means for transmitting an indication of an update from an initial parameter set of the ISO communication link to the first parameter set, where the indication includes an ID of the first parameter set and a time at which the first parameter set is to be applied. The data component 1006 is capable of, configured to, or operable to support a means for communicating, prior to the time at which the first parameter set is to be applied, using the initial parameter set and, after the time at which the first parameter set is to be applied, using the first parameter set.

In some implementations, the configuration generation component 1008 is capable of, configured to, or operable to support a means for transmitting, from a central host of the first wireless communication device to a central controller of the first wireless communication device, requests to create a set of multiple parameter sets, the set of multiple parameter sets including the one or more parameter sets. In some implementations, the configuration generation component 1008 is capable of, configured to, or operable to support a means for receiving, at the central host from the central controller, accept indications associated with the one or more parameter sets.

In some implementations, the configuration generation component 1008 is capable of, configured to, or operable to support a means for receiving, at the central host from the central controller, one or more reject indications associated with one or more second parameter sets, where the set of multiple parameter sets includes the one or more parameter sets and the one or more second parameter sets, and where the one or more parameter sets excludes the one or more second parameter sets in accordance with the one or more reject indications associated with the one or more second parameter sets.

In some implementations, the link configuration component 1002 is capable of, configured to, or operable to support a means for receiving a reject indication associated with a second parameter set of the one or more parameter sets. In some implementations, the link update component 1004 is capable of, configured to, or operable to support a means for refraining from transmitting a second indication of a second update to the second parameter set in accordance with the reject indication associated with the second parameter set.

In some implementations, any rejected parameter sets of the one or more parameter sets are unused for communication with at least the second wireless communication device. In some implementations, a rejected parameter set is a parameter set of the one or more parameter sets for which at least one wireless communication device transmits a reject indication instead of an accept indication.

In some implementations, the link configuration component 1002 is capable of, configured to, or operable to support a means for receiving a second accept indication associated with a second parameter set of the one or more parameter sets. In some implementations, the link update component 1004 is capable of, configured to, or operable to support a means for transmitting a second indication of a second update from the first parameter set to the second parameter set, where the second indication includes a second ID of the second parameter set and a second time at which the second parameter set is to be applied. In some implementations, the data component 1006 is capable of, configured to, or operable to support a means for communicating, prior to the second time at which the second parameter set is to be applied, using the first parameter set and, after the second time at which the second parameter set is to be applied, using the second parameter set.

In some implementations, the link update component 1004 is capable of, configured to, or operable to support a means for transmitting, via the indication of the update to the first parameter set, an indication of a flush rule associated with the update to the first parameter set.

In some implementations, the flush rule is exclusively applied to one or more transition protocol data units that are generated prior to the time at which the first parameter set is to be applied and, in accordance with an initial flush rule associated with the initial parameter set, have one or more respective original flush points after the time at which the first parameter set is to be applied.

In some implementations, the data flushing component 1014 is capable of, configured to, or operable to support a means for flushing, in accordance with the flush rule, one or more protocol data units associated with communication using the initial parameter set during a final ISO interval prior to the time at which the first parameter set is to be applied.

In some implementations, the link update component 1004 is capable of, configured to, or operable to support a means for transmitting, via the indication of the update to the first parameter set, an offset from an ISO event associated with the initial parameter set, where the time at which the first parameter set is to be applied is associated with the offset.

In some implementations, the coexistence component 1010 is capable of, configured to, or operable to support a means for detecting a change to one or more communication parameters associated with a wireless communication link of a second wireless communication technology different from a first wireless communication technology associated with the ISO communication link. In some implementations, the link update component 1004 is capable of, configured to, or operable to support a means for transmitting the indication of the update to the first parameter set in accordance with the change to the one or more communication parameters associated with the wireless communication link of the second wireless communication technology.

In some implementations, to support detecting the change to the one or more communication parameters associated with the wireless communication link of the second wireless communication technology, the coexistence component 1010 is capable of, configured to, or operable to support a means for receiving a request for the update to the first parameter set in accordance with the change to the one or more communication parameters associated with the wireless communication link of the second wireless communication technology.

In some implementations, the coexistence component 1010 is capable of, configured to, or operable to support a means for detecting the change at a first component of the first wireless communication device. In some implementations, the link update component 1004 is capable of, configured to, or operable to support a means for initiating the update from the first component of the first wireless communication device that detects the change.

In some implementations, the first component of the first wireless communication device is a central host of the first wireless communication device or a central controller of the first wireless communication device.

In some implementations, the first parameter set is associated with one or both of a shorter ISO interval and a smaller bandwidth than the initial parameter set. In some implementations, the update to the first parameter set is associated with an alignment of first communication via the ISO communication link with second communication via the wireless communication link of the second wireless communication technology.

In some implementations, the link update component 1004 is capable of, configured to, or operable to support a means for performing the update to the first parameter set at the time at which the first parameter set is to be applied in accordance with transmitting the indication of the update, where the update is performed while a channel associated with the ISO communication link is active.

In some implementations, each respective set of ISO parameters includes one or more NSE parameters, one or more burst number parameters, a flush timeout parameter, an ISO interval parameter, one or more maximum protocol data unit parameters, one or more physical layer parameters, one or more sub-event interval parameters, a packing mode parameter, or any combination thereof.

In some implementations, the first parameter set is associated with a host portion and a controller portion. In some implementations, the host portion includes a parameter set ID, a mode ID, and a set of application-specific parameters associated with the first parameter set. In some implementations, the controller portion includes a set of ISO parameters. In some implementations, the set of ISO parameters is calculated based on the set of application-specific parameters associated with the first parameter set.

In some implementations, communicating includes transmitting one or more first protocol data units to, or receiving one or more second protocol data units from, at least the second wireless communication device in accordance with the ISO communication link.

In some implementations, the first wireless communication device is a central device and the second wireless communication device is a remote device.

Additionally, or alternatively, the wireless communication device 1000 may support wireless communication in accordance with examples as disclosed herein. In some implementations, the link configuration component 1002 is capable of, configured to, or operable to support a means for receiving information associated with one or more parameter sets of an ISO communication link between a first wireless communication device and at least a second wireless communication device. In some implementations, the link configuration component 1002 is capable of, configured to, or operable to support a means for transmitting an accept indication associated with at least a first parameter set of the one or more parameter sets. In some implementations, the link update component 1004 is capable of, configured to, or operable to support a means for receiving an indication of an update from an initial parameter set of the ISO communication link to the first parameter set, where the indication includes an ID of the first parameter set and a time at which the first parameter set is to be applied. In some implementations, the data component 1006 is capable of, configured to, or operable to support a means for communicating, prior to the time at which the first parameter set is to be applied, using the initial parameter set of the ISO communication link and, after the time at which the first parameter set is to be applied, using the first parameter set.

In some implementations, the link configuration component 1002 is capable of, configured to, or operable to support a means for receiving the information associated with the one or more parameter sets at the second wireless communication device from the first wireless communication device. In some implementations, the link configuration component 1002 is capable of, configured to, or operable to support a means for transmitting the accept indication associated with the first parameter set from the second wireless communication device to the first wireless communication device. In some implementations, the memory storage component 1012 is capable of, configured to, or operable to support a means for storing, in a memory of the second wireless communication device, the first parameter set in accordance with the accept indication associated with the first parameter set.

In some implementations, the link configuration component 1002 is capable of, configured to, or operable to support a means for transmitting, from the second wireless communication device to the first wireless communication device, a reject indication associated with a second parameter set of the one or more parameter sets. In some implementations, the memory storage component 1012 is capable of, configured to, or operable to support a means for discarding, from a memory of the second wireless communication device, the second parameter set in accordance with the reject indication associated with the second parameter set.

In some implementations, any rejected parameter sets of the one or more parameter sets are unused for communication with at least the second wireless communication device. In some implementations, a rejected parameter set is a parameter set of the one or more parameter sets for which at least one wireless communication device transmits a reject indication instead of an accept indication.

In some implementations, the link configuration component 1002 is capable of, configured to, or operable to support a means for transmitting a second accept indication associated with a second parameter set of the one or more parameter sets. In some implementations, the link update component 1004 is capable of, configured to, or operable to support a means for receiving a second indication of a second update from the first parameter set to the second parameter set, where the second indication includes a second ID of the second parameter set and a second time at which the second parameter set is to be applied. In some implementations, the data component 1006 is capable of, configured to, or operable to support a means for communicating, prior to the second time at which the second parameter set is to be applied, using the first parameter set and, after the second time at which the second parameter set is to be applied, using the second parameter set.

In some implementations, the link update component 1004 is capable of, configured to, or operable to support a means for receiving, via the indication of the update to the first parameter set, an indication of a flush rule associated with the update to the first parameter set.

In some implementations, the flush rule is exclusively applied to one or more transition protocol data units that are generated prior to the time at which the first parameter set is to be applied and, in accordance with an initial flush rule associated with the initial parameter set, have one or more respective original flush points after the time at which the first parameter set is to be applied.

In some implementations, the data flushing component 1014 is capable of, configured to, or operable to support a means for flushing, in accordance with the flush rule, one or more protocol data units associated with communication using the initial parameter set during a final ISO interval prior to the time at which the first parameter set is to be applied.

In some implementations, the link update component 1004 is capable of, configured to, or operable to support a means for receiving, via the indication of the update to the first parameter set, an offset from an ISO event associated with the initial parameter set, where the time at which the first parameter set is to be applied is associated with the offset.

In some implementations, the link update component 1004 is capable of, configured to, or operable to support a means for performing the update to the first parameter set at the time at which the first parameter set is to be applied in accordance with transmitting the indication of the update, where the update is performed while a channel associated with the ISO communication link is active.

In some implementations, each respective set of ISO parameters includes one or more NSE parameters, one or more burst number parameters, a flush timeout parameter, an ISO interval parameter, one or more maximum protocol data unit parameters, one or more physical layer parameters, one or more sub-event interval parameters, a packing mode parameter, or any combination thereof.

In some implementations, the first parameter set is associated with a host portion and a controller portion. In some implementations, the host portion includes a parameter set ID, a mode ID, and a set of application-specific parameters associated with the first parameter set. In some implementations, the controller portion includes a set of ISO parameters. In some implementations, the set of ISO parameters is calculated based on the set of application-specific parameters associated with the first parameter set.

In some implementations, communicating includes transmitting one or more first protocol data units to, or receiving one or more second protocol data units from, the first wireless communication device in accordance with the ISO communication link.

In some implementations, the first wireless communication device is a central device and the second wireless communication device is a remote device.

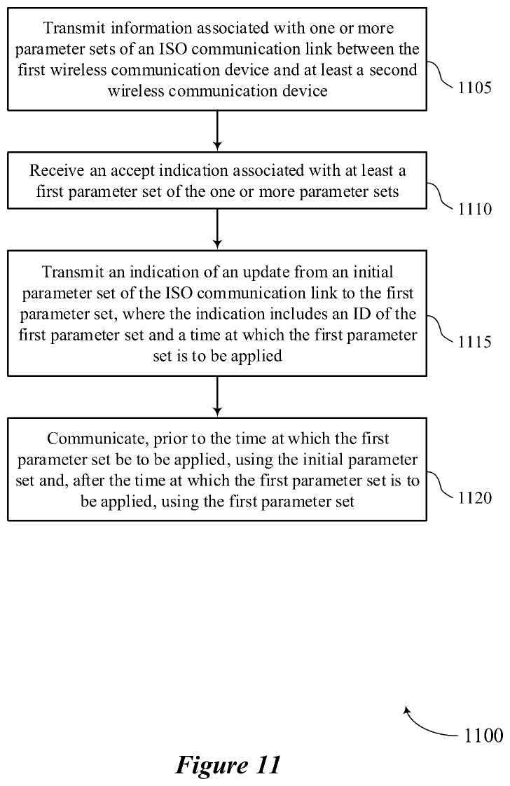

FIG. 11 shows a flowchart illustrating a method 1100 that supports dynamic ISO parameter updates for BLE communication links according to some aspects of the present disclosure. The operations of the method 1100 may be implemented by a wireless communication device, such as a central device 205, or its components as described herein. For example, the operations of the method 1100 may be performed by a wireless communication device as described with reference to FIG. 10. In some implementations, a wireless communication device may execute a set of instructions to control the functional elements of the wireless communication device to perform the described functions. Additionally, or alternatively, the wireless communication device may perform aspects of the described functions using special-purpose hardware.

At 1105, the method may include transmitting information associated with one or more parameter sets of an ISO communication link between the first wireless communication device and at least a second wireless communication device. The operations of 1105 may be performed in accordance with examples as disclosed herein. In some implementations, aspects of the operations of 1105 may be performed by a link configuration component 1002 as described with reference to FIG. 10.

At 1110, the method may include receiving an accept indication associated with at least a first parameter set of the one or more parameter sets. The operations of 1110 may be performed in accordance with examples as disclosed herein. In some implementations, aspects of the operations of 1110 may be performed by a link configuration component 1002 as described with reference to FIG. 10.

At 1115, the method may include transmitting an indication of an update from an initial parameter set of the ISO communication link to the first parameter set, where the indication includes an ID of the first parameter set and a time at which the first parameter set is to be applied. The operations of 1115 may be performed in accordance with examples as disclosed herein. In some implementations, aspects of the operations of 1115 may be performed by a link update component 1004 as described with reference to FIG. 10.

At 1120, the method may include communicating, prior to the time at which the first parameter set is to be applied, using the initial parameter set and, after the time at which the first parameter set is to be applied, using the first parameter set. The operations of 1120 may be performed in accordance with examples as disclosed herein. In some implementations, aspects of the operations of 1120 may be performed by a data component 1006 as described with reference to FIG. 10.

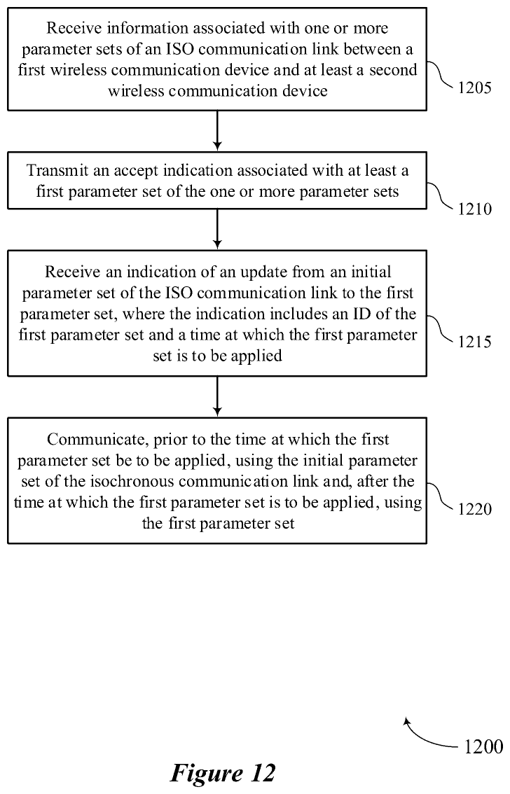

FIG. 12 shows a flowchart illustrating a method 1200 that supports dynamic ISO parameter updates for BLE communication links according to some aspects of the present disclosure. The operations of the method 1200 may be implemented by a wireless communication device, such as a remote device 210, or its components as described herein. For example, the operations of the method 1200 may be performed by a wireless communication device as described with reference FIG. 10. In some implementations, a wireless communication device may execute a set of instructions to control the functional elements of the wireless communication device to perform the described functions. Additionally, or alternatively, the wireless communication device may perform aspects of the described functions using special-purpose hardware.

At 1205, the method may include receiving information associated with one or more parameter sets of an ISO communication link between a first wireless communication device and at least a second wireless communication device. The operations of 1205 may be performed in accordance with examples as disclosed herein. In some implementations, aspects of the operations of 1205 may be performed by a link configuration component 1002 as described with reference to FIG. 10.

At 1210, the method may include transmitting an accept indication associated with at least a first parameter set of the one or more parameter sets. The operations of 1210 may be performed in accordance with examples as disclosed herein. In some implementations, aspects of the operations of 1210 may be performed by a link configuration component 1002 as described with reference to FIG. 10.

At 1215, the method may include receiving an indication of an update from an initial parameter set of the ISO communication link to the first parameter set, where the indication includes an ID of the first parameter set and a time at which the first parameter set is to be applied. The operations of 1215 may be performed in accordance with examples as disclosed herein. In some implementations, aspects of the operations of 1215 may be performed by a link update component 1004 as described with reference to FIG. 10.

At 1220, the method may include communicating, prior to the time at which the first parameter set is to be applied, using the initial parameter set of the ISO communication link and, after the time at which the first parameter set is to be applied, using the first parameter set. The operations of 1220 may be performed in accordance with examples as disclosed herein. In some implementations, aspects of the operations of 1220 may be performed by a data component 1006 as described with reference to FIG. 10.

Implementation examples are described in the following numbered clauses:
Clause 1: A method for wireless communication performable at a first wireless communication device, comprising: transmitting information associated with one or more parameter sets of an ISO communication link between the first wireless communication device and at least a second wireless communication device; receiving an accept indication associated with at least a first parameter set of the one or more parameter sets; transmitting an indication of an update from an initial parameter set of the ISO communication link to the first parameter set, wherein the indication comprises an ID of the first parameter set and a time at which the first parameter set is to be applied; and communicating, prior to the time at which the first parameter set is to be applied, using the initial parameter set and, after the time at which the first parameter set is to be applied, using the first parameter set.
Clause 2: The method of clause 1, further comprising: transmitting, from a central host of the first wireless communication device to a central controller of the first wireless communication device, requests to create a plurality of parameter sets, the plurality of parameter sets including the one or more parameter sets; and receiving, at the central host from the central controller, accept indications associated with the one or more parameter sets.
Clause 3: The method of clause 2, further comprising: receiving, at the central host from the central controller, one or more reject indications associated with one or more second parameter sets, wherein the plurality of parameter sets includes the one or more parameter sets and the one or more second parameter sets, and wherein the one or more parameter sets excludes the one or more second parameter sets in accordance with the one or more reject indications associated with the one or more second parameter sets.
Clause 4: The method of any of clauses 1 through 3, further comprising: receiving a reject indication associated with a second parameter set of the one or more parameter sets; and refraining from transmitting a second indication of a second update to the second parameter set in accordance with the reject indication associated with the second parameter set.
Clause 5: The method of clause 4, wherein any rejected parameter sets of the one or more parameter sets are unused for communication with at least the second wireless communication device, and a rejected parameter set is a parameter set of the one or more parameter sets for which at least one wireless communication device transmits a reject indication instead of an accept indication.
Clause 6: The method of any of clauses 1 through 5, further comprising: receiving a second accept indication associated with a second parameter set of the one or more parameter sets; transmitting a second indication of a second update from the first parameter set to the second parameter set, wherein the second indication comprises a second ID of the second parameter set and a second time at which the second parameter set is to be applied; and communicating, prior to the second time at which the second parameter set is to be applied, using the first parameter set and, after the second time at which the second parameter set is to be applied, using the second parameter set.
Clause 7: The method of any of clauses 1 through 6, further comprising: transmitting, via the indication of the update to the first parameter set, an indication of a flush rule associated with the update to the first parameter set.
Clause 8: The method of clause 7, wherein the flush rule is exclusively applied to one or more transition protocol data units that are generated prior to the time at which the first parameter set is to be applied and, in accordance with an initial flush rule associated with the initial parameter set, have one or more respective original flush points after the time at which the first parameter set is to be applied.
Clause 9: The method of any of clauses 7 through 8, further comprising: flushing, in accordance with the flush rule, one or more protocol data units associated with communication using the initial parameter set during a final ISO interval prior to the time at which the first parameter set is to be applied.
Clause 10: The method of any of clauses 1 through 9, further comprising: transmitting, via the indication of the update to the first parameter set, an offset from an ISO event associated with the initial parameter set, wherein the time at which the first parameter set is to be applied is associated with the offset.
Clause 11: The method of any of clauses 1 through 10, further comprising: detecting a change to one or more communication parameters associated with a wireless communication link of a second wireless communication technology different from a first wireless communication technology associated with the ISO communication link; and transmitting the indication of the update to the first parameter set in accordance with the change to the one or more communication parameters associated with the wireless communication link of the second wireless communication technology.
Clause 12: The method of clause 11, wherein detecting the change to the one or more communication parameters associated with the wireless communication link of the second wireless communication technology comprises: receiving a request for the update to the first parameter set in accordance with the change to the one or more communication parameters associated with the wireless communication link of the second wireless communication technology.
Clause 13: The method of any of clauses 11 through 12, further comprising: detecting the change at a first component of the first wireless communication device; and initiating the update from the first component of the first wireless communication device that detects the change.
Clause 14: The method of clause 13, wherein the first component of the first wireless communication device is a central host of the first wireless communication device or a central controller of the first wireless communication device.
Clause 15: The method of any of clauses 11 through 14, wherein the first parameter set is associated with one or both of a shorter ISO interval and a smaller bandwidth than the initial parameter set, and the update to the first parameter set is associated with an alignment of first communication via the ISO communication link with second communication via the wireless communication link of the second wireless communication technology.
Clause 16: The method of any of clauses 1 through 15, further comprising: performing the update to the first parameter set at the time at which the first parameter set is to be applied in accordance with transmitting the indication of the update, wherein the update is performed while a channel associated with the ISO communication link is active.
Clause 17: The method of any of clauses 1 through 16, wherein each respective set of ISO parameters includes one or more NSE parameters, one or more burst number parameters, a flush timeout parameter, an ISO interval parameter, one or more maximum protocol data unit parameters, one or more physical layer parameters, one or more sub-event interval parameters, a packing mode parameter, or any combination thereof.
Clause 18: The method of any of clauses 1 through 17, wherein the first parameter set is associated with a host portion and a controller portion, the host portion includes a parameter set ID, a mode ID, and a set of application-specific parameters associated with the first parameter set, the controller portion includes a set of ISO parameters, and the set of ISO parameters is calculated based at least in part on the set of application-specific parameters associated with the first parameter set.
Clause 19: The method of any of clauses 1 through 18, wherein communicating comprises transmitting one or more first protocol data units to, or receiving one or more second protocol data units from, at least the second wireless communication device in accordance with the ISO communication link.
Clause 20: The method of any of clauses 1 through 19, wherein the first wireless communication device is a central device and the second wireless communication device is a remote device.
Clause 21: A method for wireless communication, comprising: receiving information associated with one or more parameter sets of an ISO communication link between a first wireless communication device and at least a second wireless communication device; transmitting an accept indication associated with at least a first parameter set of the one or more parameter sets; receiving an indication of an update from an initial parameter set of the ISO communication link to the first parameter set, wherein the indication comprises an ID of the first parameter set and a time at which the first parameter set is to be applied; and communicating, prior to the time at which the first parameter set is to be applied, using the initial parameter set of the ISO communication link and, after the time at which the first parameter set is to be applied, using the first parameter set.
Clause 22: The method of clause 21, further comprising: receiving the information associated with the one or more parameter sets at the second wireless communication device from the first wireless communication device; transmitting the accept indication associated with the first parameter set from the second wireless communication device to the first wireless communication device; and storing, in a memory of the second wireless communication device, the first parameter set in accordance with the accept indication associated with the first parameter set.
Clause 23: The method of any of clauses 21 through 22, further comprising: transmitting, from the second wireless communication device to the first wireless communication device, a reject indication associated with a second parameter set of the one or more parameter sets; and discarding, from a memory of the second wireless communication device, the second parameter set in accordance with the reject indication associated with the second parameter set.
Clause 24: The method of clause 23, wherein any rejected parameter sets of the one or more parameter sets are unused for communication with at least the second wireless communication device, and a rejected parameter set is a parameter set of the one or more parameter sets for which at least one wireless communication device transmits a reject indication instead of an accept indication.
Clause 25: The method of any of clauses 21 through 24, further comprising: transmitting a second accept indication associated with a second parameter set of the one or more parameter sets; receiving a second indication of a second update from the first parameter set to the second parameter set, wherein the second indication comprises a second ID of the second parameter set and a second time at which the second parameter set is to be applied; and communicating, prior to the second time at which the second parameter set is to be applied, using the first parameter set and, after the second time at which the second parameter set is to be applied, using the second parameter set.
Clause 26: The method of any of clauses 21 through 25, further comprising: receiving, via the indication of the update to the first parameter set, an indication of a flush rule associated with the update to the first parameter set.
Clause 27: The method of clause 26, wherein the flush rule is exclusively applied to one or more transition protocol data units that are generated prior to the time at which the first parameter set is to be applied and, in accordance with an initial flush rule associated with the initial parameter set, have one or more respective original flush points after the time at which the first parameter set is to be applied.
Clause 28: The method of any of clauses 26 through 27, further comprising: flushing, in accordance with the flush rule, one or more protocol data units associated with communication using the initial parameter set during a final ISO interval prior to the time at which the first parameter set is to be applied.
Clause 29: The method of any of clauses 21 through 28, further comprising: receiving, via the indication of the update to the first parameter set, an offset from an ISO event associated with the initial parameter set, wherein the time at which the first parameter set is to be applied is associated with the offset.
Clause 30: The method of any of clauses 21 through 29, further comprising: performing the update to the first parameter set at the time at which the first parameter set is to be applied in accordance with transmitting the indication of the update, wherein the update is performed while a channel associated with the ISO communication link is active.
Clause 31: The method of any of clauses 21 through 30, wherein each respective set of ISO parameters includes one or more NSE parameters, one or more burst number parameters, a flush timeout parameter, an ISO interval parameter, one or more maximum protocol data unit parameters, one or more physical layer parameters, one or more sub-event interval parameters, a packing mode parameter, or any combination thereof.
Clause 32: The method of any of clauses 21 through 31, wherein the first parameter set is associated with a host portion and a controller portion, the host portion includes a parameter set ID, a mode ID, and a set of application-specific parameters associated with the first parameter set, the controller portion includes a set of ISO parameters, and the set of ISO parameters is calculated based at least in part on the set of application-specific parameters associated with the first parameter set.
Clause 33: The method of any of clauses 21 through 32, wherein communicating comprises transmitting one or more first protocol data units to, or receiving one or more second protocol data units from, the first wireless communication device in accordance with the ISO communication link.
Clause 34: The method of any of clauses 21 through 33, wherein the first wireless communication device is a central device and the second wireless communication device is a remote device.
Clause 35: A first wireless communication device, comprising at least one memory; and at least one processor communicatively coupled with the at least one memory, the at least one processor operable to cause the first wireless communication device to perform a method of any of clauses 1 through 20.
Clause 36: An apparatus for wireless communication performable at a first wireless communication device, comprising at least one means for performing a method of any of clauses 1 through 20.
Clause 37: A non-transitory computer-readable medium storing code for wireless communication performable at a first wireless communication device, the code comprising instructions executable by at least one processor to perform a method of any of clauses 1 through 20.
Clause 38: A second wireless communication device, comprising at least one memory; and at least one processor communicatively coupled with the at least one memory, the at least one processor operable to cause the second wireless communication device to perform a method of any of clauses 21 through 34.
Clause 39: An apparatus for wireless communication, comprising at least one means for performing a method of any of clauses 21 through 34.
Clause 40: A non-transitory computer-readable medium storing code for wireless communication, the code comprising instructions executable by at least one processor to perform a method of any of clauses 21 through 34.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like.

Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function.

Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A first wireless communication device, comprising:
at least one memory; and
at least one processor communicatively coupled with the at least one memory, the at least one processor operable to cause the first wireless communication device to:
transmit information associated with one or more parameter sets of an isochronous communication link between the first wireless communication device and at least a second wireless communication device;
receive an accept indication associated with at least a first parameter set of the one or more parameter sets;
transmit an indication of an update from an initial parameter set of the isochronous communication link to the first parameter set, wherein the indication comprises an identifier of the first parameter set and a time at which the first parameter set is to be applied; and
communicate, prior to the time at which the first parameter set be to be applied, using the initial parameter set and, after the time at which the first parameter set is to be applied, using the first parameter set.

2. The first wireless communication device of claim 1, wherein the at least one processor is further operable to cause the first wireless communication device to:
transmit, from a central host of the first wireless communication device to a central controller of the first wireless communication device, requests to create a plurality of parameter sets, the plurality of parameter sets including the one or more parameter sets; and
receive, at the central host from the central controller, accept indications associated with the one or more parameter sets.

3. The first wireless communication device of claim 2, wherein the at least one processor is further operable to cause the first wireless communication device to:
receive, at the central host from the central controller, one or more reject indications associated with one or more second parameter sets, wherein the plurality of parameter sets includes the one or more parameter sets and the one or more second parameter sets, and wherein the one or more parameter sets excludes the one or more second parameter sets in accordance with the one or more reject indications associated with the one or more second parameter sets.

4. The first wireless communication device of claim 1, wherein the at least one processor is further operable to cause the first wireless communication device to:
receive a reject indication associated with a second parameter set of the one or more parameter sets; and
refrain from transmitting a second indication of a second update to the second parameter set in accordance with the reject indication associated with the second parameter set.

5. The first wireless communication device of claim 4, wherein any rejected parameter sets of the one or more parameter sets are unused for communication with at least the second wireless communication device, and wherein a rejected parameter set is a parameter set of the one or more parameter sets for which at least one wireless communication device transmits a reject indication instead of an accept indication.

6. The first wireless communication device of claim 1, wherein the at least one processor is further operable to cause the first wireless communication device to:
receive a second accept indication associated with a second parameter set of the one or more parameter sets;
transmit a second indication of a second update from the first parameter set to the second parameter set, wherein the second indication comprises a second identifier of the second parameter set and a second time at which the second parameter set is to be applied; and
communicate, prior to the second time at which the second parameter set be to be applied, using the first parameter set and, after the second time at which the second parameter set is to be applied, using the second parameter set.

7. The first wireless communication device of claim 1, wherein the at least one processor is further operable to cause the first wireless communication device to:
transmit, via the indication of the update to the first parameter set, an indication of a flush rule associated with the update to the first parameter set.

8. The first wireless communication device of claim 7, wherein the flush rule is exclusively applied to one or more transition protocol data units that are generated prior to the time at which the first parameter set is to be applied and, in accordance with an initial flush rule associated with the initial parameter set, have one or more respective original flush points after the time at which the first parameter set is to be applied.

9. The first wireless communication device of claim 7, wherein the at least one processor is further operable to cause the first wireless communication device to:
flush, in accordance with the flush rule, one or more protocol data units associated with communication using the initial parameter set during a final isochronous interval prior to the time at which the first parameter set is to be applied.

10. The first wireless communication device of claim 1, wherein the at least one processor is further operable to cause the first wireless communication device to:
transmit, via the indication of the update to the first parameter set, an offset from an isochronous event associated with the initial parameter set, wherein the time at which the first parameter set is to be applied is associated with the offset.

11. The first wireless communication device of claim 1, wherein the at least one processor is further operable to cause the first wireless communication device to:
detect a change to one or more communication parameters associated with a wireless communication link of a second wireless communication technology different from a first wireless communication technology associated with the isochronous communication link; and
transmit the indication of the update to the first parameter set in accordance with the change to the one or more communication parameters associated with the wireless communication link of the second wireless communication technology.

12. The first wireless communication device of claim 11, wherein, to detect the change to the one or more communication parameters associated with the wireless communication link of the second wireless communication technology, the at least one processor is operable to cause the first wireless communication device to:
receive a request for the update to the first parameter set in accordance with the change to the one or more communication parameters associated with the wireless communication link of the second wireless communication technology.

13. The first wireless communication device of claim 11, wherein the at least one processor is further operable to cause the first wireless communication device to:
detect the change at a first component of the first wireless communication device; and
initiate the update from the first component of the first wireless communication device that detects the change.

14. The first wireless communication device of claim 13, wherein the first component of the first wireless communication device is a central host of the first wireless communication device or a central controller of the first wireless communication device.

15. The first wireless communication device of claim 11, wherein the first parameter set is associated with one or both of a shorter isochronous interval and a smaller bandwidth than the initial parameter set, and wherein the update to the first parameter set is associated with an alignment of first communication via the isochronous communication link with second communication via the wireless communication link of the second wireless communication technology.

16. The first wireless communication device of claim 1, wherein the at least one processor is further operable to cause the first wireless communication device to:
perform the update to the first parameter set at the time at which the first parameter set is to be applied in accordance with transmitting the indication of the update, wherein the update is performed while a channel associated with the isochronous communication link is active.

17. The first wireless communication device of claim 1, wherein each respective set of isochronous parameters includes one or more number of sub-events (NSE) parameters, one or more burst number parameters, a flush timeout parameter, an isochronous interval parameter, one or more maximum protocol data unit parameters, one or more physical layer parameters, one or more sub-event interval parameters, a packing mode parameter, or any combination thereof.

18. The first wireless communication device of claim 1, wherein the first parameter set is associated with a host portion and a controller portion, wherein the host portion includes a parameter set identifier, a mode identifier, and a set of application-specific parameters associated with the first parameter set, wherein the controller portion includes a set of isochronous parameters, and wherein the set of isochronous parameters is calculated based at least in part on the set of application-specific parameters associated with the first parameter set.

19-20. (canceled)

21. A second wireless communication device for wireless communication, comprising:
at least one memory; and
at least one processor communicatively coupled with the at least one memory, the at least one processor operable to cause the second wireless communication device to:
receive information associated with one or more parameter sets of an isochronous communication link between a first wireless communication device and at least a second wireless communication device;
transmit an accept indication associated with at least a first parameter set of the one or more parameter sets;
receive an indication of an update from an initial parameter set of the isochronous communication link to the first parameter set, wherein the indication comprises an identifier of the first parameter set and a time at which the first parameter set is to be applied; and
communicate, prior to the time at which the first parameter set be to be applied, using the initial parameter set of the isochronous communication link and, after the time at which the first parameter set is to be applied, using the first parameter set.

22-28. (canceled)

29. A method for wireless communication performable at a first wireless communication device, comprising:
transmitting information associated with one or more parameter sets of an isochronous communication link between the first wireless communication device and at least a second wireless communication device;
receiving an accept indication associated with at least a first parameter set of the one or more parameter sets;
transmitting an indication of an update from an initial parameter set of the isochronous communication link to the first parameter set, wherein the indication comprises an identifier of the first parameter set and a time at which the first parameter set is to be applied; and
communicating, prior to the time at which the first parameter set is to be applied, using the initial parameter set and, after the time at which the first parameter set is to be applied, using the first parameter set.

30. (canceled)
